(19) United States
(12) Patent Application Publication
(10) Pub. No.: US 2026/0255329 A1
(43) Pub. Date: Aug. 27, 2026

(54) RESOURCE PATTERN CONFIGURATIONS FOR WIRELESS COMMUNICATION

(71) Applicant: Lenovo (United States) Inc., Morrisville, NC (US)

(72) Inventor: Hyejung Jung, Palatine, IL (US)

(73) Assignee: Lenovo (United States) Inc., Morrisville, NC (US)

(21) Appl. No.: 19/461,657

(22) Filed: Jan. 27, 2026

(51) Int. Cl. H04W 72/0446

(52) U.S. Cl. CPC H04W 72/0446

(57) ABSTRACT

Various aspects of the present disclosure relate to resource pattern configurations for wireless communication. A network entity (NE) transmits, to a user equipment (UE), a set of resource configurations, each resource pattern indicating a pattern of resources, where each pattern of resources is associated with a respective type of communication, and where each resource configuration further indicates a periodicity of the pattern of resources. The UE receives the set of resource configurations and performs communications in accordance with the set of resource configurations. The communication type for each resource configuration may include uplink, downlink, subband full duplex (SBFD), flexible, or reserved. The resource configurations may be cell-specific, applying to all UEs within a cell, or UE-specific, applying to individual UEs. A resource configuration associated with SBFD may further indicate frequency information for the at least one resource occasion, such as a resource indication value (RIV).

### TECHNICAL FIELD

The present disclosure relates to wireless communications, and more specifically to resource allocation for wireless communications.

### BACKGROUND

A wireless communications system may include one or multiple network communication devices, which may be otherwise known as network entity (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a set of resource configurations, each resource configuration indicating a pattern of resources, where each pattern of resources is associated with a single respective type of communication, and where each resource configuration further indicates a periodicity of the pattern of resources, and perform the wireless communication in accordance with the set of resource configurations.

A processor (e.g., a standalone processor chipset, or a component of a UE) for wireless communication is described. The processor may be configured to, capable of, or operable to perform one or more operations as described herein. For example, the processor may be configured to, capable of, or operable to receive a set of resource configurations, each resource configuration indicating a pattern of resources, where each pattern of resources is associated with a single respective type of communication, and where each resource configuration further indicates a periodicity of the pattern of resources, and perform the wireless communication in accordance with the set of resource configurations.

A method performed or performable by a UE for wireless communication is described. The method may include receiving a set of resource configurations, each resource configuration indicating a pattern of resources, where each pattern of resources is associated with a respective type of communication, and where each resource configuration further indicates a periodicity of the pattern of resources, and performing the wireless communication in accordance with the set of resource configurations.

In some implementations of the UE, the processor, and the method described herein, the set of resource configurations includes a resource configuration indicating a pattern of resources associated with a flexible type of communication, and a communication direction for the flexible type of communication is determined based on at least one of a dynamic indication, a semi-static resource configuration of a physical channel, or a semi-static resource configuration of a physical signal. In some implementations of the UE, the processor, and the method described herein, the set of resource configurations includes a resource configuration indicating a pattern of resources associated with a reserved communication type, and resources indicated by the pattern of resources associated with the reserved communication type are unavailable for the UE. In some implementations of the UE, the processor, and the method described herein, each resource configuration includes a communication type field indicating one of an uplink type of communication, a downlink type of communication, or a subband full duplex (SBFD) type of communication, and each resource configuration further indicates timing information for at least one resource occasion within the periodicity of the pattern of resources.

In some implementations of the UE, the processor, and the method described herein, the set of resource configurations includes a resource configuration indicating a pattern of resources associated with an SBFD type of communication, and the resource configuration further indicates frequency information for the at least one resource occasion. In some implementations, the UE, the processor, and the method may further be configured to, capable of, or operable to receive an indication that resources excluded from the set of resource configurations are unavailable for the UE. In some implementations, the UE, the processor, and the method may further be configured to, capable of, or operable to determine a type of communication for resources excluded from the set of resource configurations based on at least one of a dynamic indication, a semi-static resource configuration of a physical channel, or a semi-static resource configuration of a physical signal. In some implementations of the UE, the processor, and the method described herein, a pattern of resources associated with an uplink type of communication is nonoverlapping with a first set of resources indicated to the UE for reception of one or more synchronization signal blocks (SSBs), and a second set of resources corresponding to a control resource set (CORESET) for reception of system information.

In some implementations of the UE, the processor, and the method described herein, a pattern of resources associated with a downlink type of communication is nonoverlapping with one or more physical random access channel (PRACH) occasions. In some implementations of the UE, the processor, and the method described herein, the set of resource configurations includes at least one of a cell-specific resource configuration or a UE-specific resource configuration. In some implementations of the UE, the processor, and the method described herein, the set of resource configurations includes both the cell-specific resource configuration and the UE-specific resource configuration, and a type of communication for a resource indicated by both the cell-specific resource configuration and the UE-specific resource configuration is determined by the cell-specific resource configuration.

In some implementations, the UE, the processor, and the method may further be configured to, capable of, or operable to receive downlink control information (DCI) scheduling a physical downlink shared channel (PDSCH) over a set of slots, and skip reception of the PDSCH in a slot of the set of slots based on a resource allocated for the PDSCH in the slot overlapping with at least one of a resource occasion of an uplink pattern of resources or an uplink subband of an SBFD pattern of resources. In some implementations, the UE, the processor, and the method may further be configured to, capable of, or operable to receive DCI scheduling a physical uplink shared channel (PUSCH) over a set of slots, and skip transmission of the PUSCH in a slot of the set of slots based on a resource allocated for the PUSCH in the slot overlapping with at least one of a resource occasion of a downlink pattern of resources or a downlink subband of an SBFD pattern of resources.

Δn NE (e.g., a base station) for wireless communication is described. The NE may be configured to, capable of, or operable to perform one or more operations as described herein. For example, the NE may be configured to, capable of, or operable to transmit, to a UE, a set of resource configurations, each resource configuration indicating a pattern of resources, where each pattern of resources is associated with a single respective type of communication, and where each resource configuration further indicates a periodicity of the pattern of resources, and perform the wireless communication with the UE in accordance with the set of resource configurations.

A processor (e.g., a standalone processor chipset, or a component of an NE) for wireless communication is described. The processor may be configured to, capable of, or operable to perform one or more operations as described herein. For example, the processor may be configured to, capable of, or operable to transmit, to a UE, a set of resource configurations, each resource configuration indicating a pattern of resources, where each pattern of resources is associated with a single respective type of communication, and where each resource configuration further indicates a periodicity of the pattern of resources, and perform the wireless communication with the UE in accordance with the set of resource configurations.

A method performed or performable by an NE (e.g., a base station) for wireless communication is described. The method may include transmitting, to a UE, a set of resource configurations, each resource pattern indicating a pattern of resources, where each pattern of resources is associated with a respective type of communication, and where each resource configuration further indicates a periodicity of the pattern of resources, and performing the wireless communication with the UE in accordance with the set of resource configurations.

In some implementations of the NE, the processor, and the method described herein, each resource configuration includes a communication type field indicating one of an uplink type of communication, a downlink type of communication, or an SBFD type of communication, and each resource configuration further indicates timing information for at least one resource occasion within the periodicity of the pattern of resources. In some implementations of the NE, the processor, and the method described herein, the set of resource configurations includes at least one of a cell-specific resource configuration or a UE-specific resource configuration. In some implementations, the NE, the processor, and the method may further be configured to, capable of, or operable to transmit the cell-specific resource configuration to a set of UEs, and transmit the UE-specific resource configuration to at least one UE of the set of UEs, where a type of communication for a resource indicated by both the cell-specific resource configuration and the UE-specific resource configuration is determined by the cell-specific resource configuration. In some implementations, the NE, the processor, and the method may further be configured to, capable of, or operable to transmit an indication that resources excluded from the set of resource configurations are unavailable for the UE.

### BRIEF DESCRIPTION OF THE DRAWINGS

FIGS. 1 and 2 illustrate examples of wireless communications systems in accordance with aspects of the present disclosure.

FIGS. 3 through 7 illustrate examples of information elements (IEs), in accordance with aspects of the present disclosure.

FIG. 8 illustrates an example cell activation/deactivation medium access control (MAC) control element (MAC-CE), in accordance with aspects of the present disclosure.

FIG. 9 illustrates an example of an IE, in accordance with aspects of the present disclosure.

FIGS. 10A and 10B illustrate examples of IE contents, in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of an NE in accordance with aspects of the present disclosure.

FIG. 14 illustrates a flowchart of a method performed by a UE in accordance with aspects of the present disclosure.

FIG. 15 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. The wireless communications system may support duplexing techniques that define how uplink and downlink transmissions are separated. In frequency division duplexing (FDD), uplink and downlink transmissions occur on separate spectrums, referred to as a paired spectrum. In time division duplexing (TDD), uplink and downlink transmissions occur on the same spectrum, referred to as an unpaired spectrum, but at different times. A slot format defines whether each symbol within a slot is allocated for downlink, uplink, or flexible use. In symbols allocated for flexible use (also referred to as flexible symbols), the direction of transmission can change dynamically based on varying traffic demands, enabling dynamic TDD operation in unpaired spectrum.

Some wireless communications systems support SBFD operation in unpaired spectrums, enabling simultaneous downlink transmission and uplink reception at an NE on non-overlapping subbands within a single carrier. However, configurations of cell-specific SBFD time and frequency resources are provided based on legacy TDD frameworks. That is, SBFD subbands can be configured in downlink symbols and flexible symbols provided by a cell-specific TDD configuration parameter. A UE determines that a downlink or flexible symbol is overridden as an SBFD symbol when the SBFD subbands are configured. This approach limits configuration flexibility in several respects. First, uplink and downlink resource occasions are tied together with the same periodicity, preventing independent configuration of uplink and downlink resources at different rates. Second, SBFD resources are layered on top of existing TDD configurations rather than being configured independently, constraining the network's ability to allocate SBFD resources without regard to the underlying TDD structure. Third, conventional systems lack the ability to configure resource patterns that apply across multiple carriers, requiring separate configuration for each carrier and increasing signaling overhead.

Additionally, in conventional carrier aggregation, when a serving cell is activated, all communication types (e.g., uplink, downlink, full duplex, and the like) associated with that carrier are activated together, and when a serving cell is deactivated, all communication types are deactivated together. This prevents the network from flexibly adjusting carrier and resource configurations to adapt to varying scenarios. For example, the network may be unable to independently activate uplink resources on one carrier while activating downlink resources on a different carrier based on channel conditions or UE location. However, such uplink-downlink decoupling may be desirable in next-generation spectrum aggregation. For example, a carrier in a higher frequency band (e.g., 3.5 gigahertz (GHz)) may provide sufficient downlink performance due to a higher network transmit power, while uplink transmissions may be better served by a carrier in a lower frequency band (e.g., 800 megahertz (MHz)) due to reduced signal attenuation and improved link budget for devices with limited transmit power. A UE located close to a network entity deployed in a higher frequency band may have sufficient uplink coverage to perform TDD or full duplex communications on that carrier, while a UE located farther from the network entity may benefit from using a lower frequency band for uplink transmissions. Accordingly, flexible and dynamic utilization of spectrum resources across multiple carriers may improve device and network energy efficiency and enhance uplink coverage in 6G radio access networks.

The techniques described herein address these limitations by enabling independent configuration of uplink, downlink, and full duplex resource patterns, and by supporting uplink-downlink decoupling across multiple serving carriers. A UE receives one or more resource pattern configurations, where each resource pattern configuration is associated with a communication type (e.g., uplink, downlink, full duplex, flexible, reserved, and so forth) and indicates a resource pattern periodicity and timing information for at least one resource occasion. For resource pattern configurations associated with SBFD, the configuration may further indicate frequency information for the resource occasion, such as a resource indication value specifying a starting resource block and a length of contiguously allocated resource blocks for an uplink or downlink subband. The resource pattern configurations may be cell-specific, applying to all UEs within a cell, or UE-specific, applying to individual UEs or groups of UEs. By configuring separate resource patterns for each communication type, the techniques described herein enable the network to tailor the periodicity and timing of resource occasions to the requirements of each communication type.

In some aspects, the techniques described herein extend to multi-carrier operation, where the UE receives a configuration for a set of serving carriers. Each serving carrier may be associated with at least one communication type including uplink, downlink, or full duplex. In such examples, each resource pattern configuration indicates a subset of serving carriers to which the resource pattern applies, enabling a single resource pattern to be applicable across multiple carriers and reducing signaling overhead compared to configuring each carrier separately. The serving carriers in the subset may be intra-band, inter-band, in a same frequency range, or in different frequency ranges relative to each other. The UE may also receive a command to activate or deactivate a single communication type for a serving carrier, rather than activating or deactivating all communication types for the carrier together. For example, the NE may activate downlink resources on a higher frequency carrier while activating uplink resources on a lower frequency carrier based on channel conditions and UE location.

The described techniques provide improvements in resource configuration for wireless communications. By decoupling resource pattern configurations from legacy TDD frameworks, the techniques described herein enable SBFD resources to be configured directly rather than layered on top of existing TDD configurations. Additionally, supporting both cell-specific and UE-specific resource pattern configurations enables the network to establish baseline resource allocations for all UEs within a cell while providing tailored resource configurations for individual UEs or groups of UEs based on traffic demands, channel conditions, or UE location. Enabling activation and/or deactivation of a single communication type for a serving carrier allows uplink-downlink decoupling, such that the network can optimize resource utilization based on the characteristics of each carrier and the geometry of each UE within the network. These approaches may improve spectrum utilization efficiency, reduce device and network energy consumption, and enhance coverage for uplink transmissions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

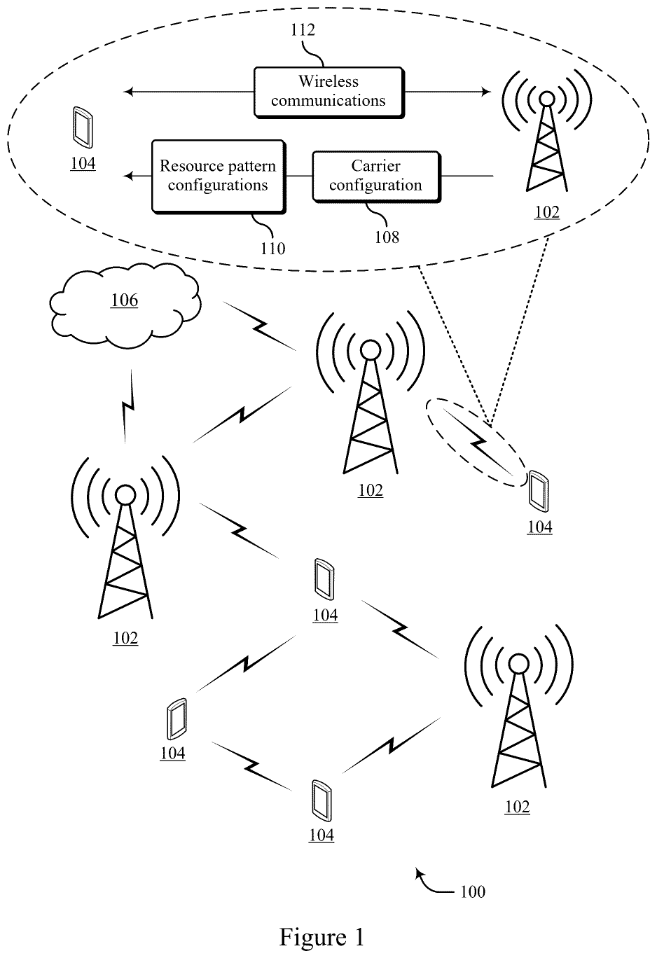

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A cell may refer to a radio access node in communication with an NE 102 or including an NE 102. A cell may have a coverage area, which is a geographic area in which the cell provides wireless connectivity to devices. Different cells may operate on defined frequencies or frequency bands, referred to as subcarriers. In some examples, a UE 104 may establish a wireless connection with a cell, and subsequently that cell may be referred to as a serving cell of the UE 104. The UE 104 may communicate with the NE 102 of the serving cell, which may be referred to as a serving base station or a serving NE 102. The UE 104 can be mobile and may travel outside of a coverage area of the serving cell (e.g., to a coverage area of a target cell), which may cause disruption in service for the UE 104. Thus, the UE 104, the serving cell (e.g., the serving NE 102), and the target cell (e.g., an NE 102 associated with the target cell, referred to as a target NE 102) can coordinate a handover procedure from the serving cell (also referred to as a source serving cell) to the target cell.

In some examples, one or more devices in the wireless communications system 100 support carrier aggregation (CA) for multiple component carriers (CCs). A CC (e.g., a communication channel in the frequency domain), also referred to interchangeably herein as a carrier, a spectrum block, a spectrum, or a cell, may be associated with characteristics such as a frequency range, a bandwidth, a data rate, throughput, and the like, and different CCs can have different such characteristics. A UE 104 that is capable of simultaneously transmitting and/or receiving on multiple CCs may be configured with a CA configuration, where a set of configured CCs corresponds to a serving cell. A CC may be configured for uplink communications, downlink communications, or both, and a quantity of CCs configured for uplink may be different from a quantity of CCs configured for downlink. Additionally, in some examples, each CC may be configured with a corresponding bandwidth part (BWP). The CCs in the set can be contiguous or non-contiguous with one another and can be in the same frequency band or in different frequency bands. Each CC may be used for FDD communications, TDD communications, or both. In FDD communications, each downlink or uplink frequency channel is individually referred to as a CC and is assigned a distinct physical carrier index, whereas in TDD communications each frequency channel with downlink and uplink partitions in time is designated as a CC and is assigned a distinct physical carrier index.

In 5G NR and earlier releases, each CC corresponds to a respective serving cell, and the UE 104 is configured with multiple serving cells. A CC corresponding to a serving cell may also be referred to herein as a serving CC or serving carrier. Of the multiple serving cells, the serving cell to which the UE 104 initially connects may be designated as the primary cell (PCell). The CC associated with the PCell may be referred to as a primary carrier or primary CC. The UE 104 may transmit all uplink data via the PCell/primary carrier, and the PCell may be the only serving cell used for communication of control signaling and user data. After connecting to the PCell, the UE 104 may connect to one or more additional serving cells, referred to as secondary cells (SCells), secondary carriers, or secondary CCs. SCells may include or be an example of downlink-only CCs, uplink-only CCs, or downlink-uplink CCs and can be added to a CA configuration as needed (e.g., based on data rates). Additionally, or alternatively, a supplemental uplink (SUL) carrier can be added in a serving cell. When a UE 104 uses multiple frequency bands or cells concurrently in CA, a PCell manages control functions and basic services, while SCells provide additional bandwidth and capacity for increasing communication throughput. Handover procedures and/or serving cell change procedures when CA is configured involve changing a PCell and an SCell (e.g., from source PCells/SCells to target PCells/SCells), as well as release or addition of additional SCells, when applicable.

Communication configurations (e.g., downlink transmission configurations, uplink transmission configurations, uplink-and-downlink transmission configurations, and the like) for a device in the wireless communications system 100 may be cell-specific and/or device-specific (e.g., UE-specific). Additionally, or alternatively, serving cell (e.g., serving carrier) configurations may be device-specific. For example, a first UE 104 may have a different PCell than a second UE 104. Additionally, or alternatively, a first UE 104 may be configured with a different active BWP or a different physical channel configuration than a second UE 104. Frame timing and system frame numbers (SFNs) are aligned across aggregated cells (e.g., of the multiple serving cells), or an offset may be configured (e.g., a multi-slot offset) between a PCell/PSCell and an SCell. The offset may be configured as part of the CA configuration. In both uplink and downlink, each serving cell is associated with one independent hybrid automatic repeat request (HARQ) entity per serving cell, and a transport block (TB) and its potential HARQ retransmissions are mapped to a single serving cell. Additionally, in CA, one or more CCs may be activated (e.g., used for transmission/reception) or deactivated (e.g., not used for transmission/reception). For instance, the UE 104 may receive MAC signaling including a bitmap, where each bit indicates whether a corresponding CC/serving cell should be activated or deactivated.

In the wireless communications system 100, a resource element (RE) is defined by one subcarrier and one symbol, and a resource block (RB) includes 12 subcarriers for all subcarrier spacings (SCS). A radio frame has a duration of 10 ms and includes 10 subframes, where each subframe has a duration of 1 ms. A slot is defined as 14 consecutive symbols for a normal cyclic prefix (CP) configuration and all SCS values. A slot may refer to a basic time unit for scheduling in the wireless communications system 100, and a duration of a slot depends on the SCS. An RB may refer to a unit of resources allocated in the frequency domain, where an RB includes multiple consecutive subcarriers (e.g., 12 consecutive subcarriers) in the frequency domain and spans one slot in the time domain. In some examples, a size of an RB in the frequency domain may be fixed (e.g., 180 kHz) regardless of the SCS. An RE includes one subcarrier during one symbol interval, and an RB includes a quantity of REs depending on the quantity of symbols in a slot.

In 5G NR, slot formats define a type and/or direction of communication for each symbol within a slot, such as whether the symbol is allocated for downlink, uplink, or flexible use. In flexible symbols, a direction of communication can change dynamically based on varying traffic demands, which enables dynamic TDD operation in unpaired spectrum. In 3GPP Release-19 5G NR, some devices (e.g., UEs 104, NEs 102, etc.) support SBFD operation in unpaired spectrum, enabling simultaneous downlink transmission and uplink reception on non-overlapping respective subbands. However, configurations of cell-specific SBFD time and frequency resources are provided for SBFD-aware UEs (i.e., UEs 104 that are capable of supporting SBFD operation) based on the legacy TDD framework. That is, SBFD subbands can be configured in downlink symbols and flexible symbols provided by a cell-specific TDD downlink/uplink configuration parameter, such as tdd-UL-DL-ConfigurationCommon. SBFD-aware UEs determine that a downlink or a flexible symbol is overridden as an SBFD symbol when the SBFD subbands (i.e., an uplink subband and one or two downlink subbands) are configured.

As used herein, a communication type refers to a type or direction of communication associated with a resource. Communication types may include, but are not limited to, uplink, downlink, full duplex, flexible, and reserved, and may indicate that associated resources are available for communications of the corresponding communication type. An uplink communication type corresponds to uplink transmission from the UE 104 to the NE 102. A downlink communication type corresponds to downlink reception at the UE 104 from the NE 102. Full duplex refers to a communication capability or mode of a UE or NE to support both uplink and downlink communication on a carrier, including the ability to transmit and receive simultaneously or, alternatively, to transmit only or receive only on the carrier. Full duplex communication types include intra-carrier full duplex, also referred to as SBFD, and inter-carrier full duplex. In intra-carrier full duplex, a carrier is configured to support simultaneous downlink transmission and uplink reception at the NE on non-overlapping subbands, where an uplink subband is used for uplink transmission and one or more downlink subbands are used for downlink reception. A UE operating in an intra-carrier full duplex mode may transmit and receive simultaneously, or may transmit only or receive only, on the carrier. In inter-carrier full duplex, simultaneous transmission and reception occur across different carriers, where a first set of carriers is used for uplink transmission and a second set of carriers is used for downlink reception. A flexible communication type indicates that a communication direction for the associated resources is not predetermined and is determined based on a dynamic indication (e.g., DCI) or a semi-static resource configuration of a physical channel or physical signal. A reserved communication type indicates that the associated resources are unavailable (e.g., for a UE 104).

In conventional systems, resource configurations for uplink, downlink, and flexible communications are provided as a bundled set with a shared periodicity. For example, in 5G NR, the tdd-UL-DL-ConfigurationCommon parameter and the tdd-UL-DL-ConfigurationDedicated parameter each define a resource pattern that includes downlink symbols, uplink symbols, and flexible symbols together within a single periodicity. The downlink and uplink resources are tied to the same periodicity, such that the occurrence rates of uplink resource occasions and downlink resource occasions are the same. This bundled approach limits the network's ability to independently configure resource occasions for different communication types at different rates. For example, the network cannot configure uplink resources to occur more frequently than downlink resources, or vice versa, without reconfiguring the entire resource pattern. Additionally, in conventional systems, SBFD resources are layered on top of existing TDD configurations using parameters such as SBFD-StartingSlotIndex, SBFD-StartingSymbolIndex, SBFD-EndingSlotIndex, and SBFD-EndingSymbolIndex, rather than being configured as independent resource patterns.

The UE 104 and the NE 102 can exchange signaling (e.g., transmit and/or receive) using one or more communication links. For example, the UE 104 receives signaling, including control information and/or data, from the NE 102 via a downlink communication link, while the NE 102 receives signaling, including control information and/or data, from the UE 104 via an uplink communication link. In some examples, a UE 104 can transmit an uplink transmission, which can include control signaling and/or data (e.g., physical uplink shared channel (PUSCH)), to the NE 102 via the uplink communication link. A PUSCH transmission may include data and, optionally, uplink control information (UCI). An NE 102 may transmit signaling to the UE 104 scheduling one or more time-frequency resources for the PUSCH transmission, including one or more RBs and symbols within a slot or multiple slots. For example, the NE 102 may dynamically schedule the PUSCH transmission using a downlink control information (DCI) message on a downlink control channel (e.g., a physical downlink control channel (PDCCH)), or semi-statically schedule the PUSCH transmission using radio resource control (RRC) signaling. In some examples, the DCI message may be transmitted within a control resource set (CORESET), which is a set of time-frequency resources of the downlink control channel.

To support UEs 104 that have varying capabilities, an NE 102 may receive UE capability information from each UE 104 within a serving cell. A UE 104 reports its capabilities to the NE 102 via RRC signaling, indicating supported features, frequency bands, carrier aggregation configurations, transmission and reception capabilities, and the like. For example, UE capability information may indicate whether the UE 104 supports simultaneous transmission and reception, the number of CCs the UE 104 can aggregate, supported SCS values, maximum supported bandwidth, and full duplex capabilities. For example, a UE 104 with inter-band carrier aggregation capability may have separate RF chains for different frequency ranges, enabling simultaneous transmission and reception across carriers without interference, while a UE 104 without separate RF chains may not be capable of full duplex. The NE 102 uses the reported UE capability information to configure appropriate serving cell parameters and, as described herein, resource pattern configurations for each UE 104.

A downlink or flexible symbol provided by a cell-specific uplink and downlink configuration can include an uplink subband, a first downlink subband, and optionally a second downlink subband for an SCS configuration u of any configured uplink BWP or downlink BWP. When the downlink or flexible symbol includes such subbands, the symbol is referred to as an SBFD symbol; otherwise, the symbol is referred to as a non-SBFD symbol. A UE 104 considers symbols in a slot indicated as downlink or as SBFD by the cell-specific uplink and downlink configuration to be available for transmissions. Uplink symbols provided by the cell-specific uplink and downlink configuration are non-SBFD symbols. An SBFD symbol or a non-SBFD symbol provided by the cell-specific uplink and downlink configuration cannot be changed to a non-SBFD symbol or to an SBFD symbol, respectively, by other information.

Conventionally, SBFD symbols are configured via a cell-specific TDD uplink/downlink configuration using the following parameters: Configured SBFD symbols are consecutive and start from a first slot provided by SBFD-StartingSlotIndex and from a first symbol in the first slot provided by SBFD-StartingSymbolIndex. The SBFD symbols end in a second slot provided by SBFD-EndingSlotIndex and in a second symbol in the second slot provided by SBFD-EndingSymbolIndex. SBFD symbols can be provided in any of pattern1 and, if provided, pattern2. A configuration period for SBFD symbols is P milliseconds when only pattern is provided, or P+P₂ milliseconds when pattern2 is additionally provided.

In conventional systems, except for a physical random access channel (PRACH) transmission in a PRACH occasion determined based on an SBFD-specific RACH configuration, a UE 104 transmits or receives a physical channel or signal either only in SBFD symbols or only in non-SBFD symbols. In some examples, a UE 104 can be configured via the cell-specific TDD UL/DL configuration to transmit or receive across both SBFD symbols and non-SBFD symbols for multiple transmission or reception occasions. When a UE 104 is provided sbfd-Config2-Transmission, the UE 104 can transmit a first PUCCH or PUSCH, or a first repetition of a PUCCH or PUSCH, in non-SBFD symbols and transmit a second PUCCH or PUSCH, or a second repetition of the PUCCH or PUSCH, in SBFD symbols. When a UE 104 is provided sbfd-Config2-Reception, the UE 104 can receive a first physical downlink shared channel (PDSCH), or a first repetition of a PDSCH, in non-SBFD symbols and receive a second PDSCH, or a second repetition of the PDSCH, in SBFD symbols. In an SBFD symbol, and except for cross-link interference measurements, a UE 104 transmits or receives only in RBs that are both in an active uplink BWP and in an uplink subband, or both in an active downlink BWP and in a downlink subband, respectively. The UE 104 does not transmit in SBFD symbols indicated for presence of synchronization signal/physical broadcast channel (SS/PBCH) blocks within the active downlink BWP.

In 6G radio access networks (RANs), downlink and uplink resource configurations may allow flexible duplexing including dynamic TDD and full duplex more systematically. Further, flexible and dynamic utilization of spectrum resources for downlink and uplink over different carriers or bands may improve UE and network energy efficiencies and enhance uplink coverage. For example, a carrier in a 3.5 GHz band may provide good downlink performance due to higher network transmit power, but uplink may be better served by a carrier in an 800 MHz band due to reduced signal attenuation and improved link budget for devices with limited transmit power. That is, uplink-downlink decoupling may be desirable in 6G spectrum aggregation. Accordingly, the techniques described herein provide methods to flexibly configure and operate downlink, uplink, and full duplex time and frequency resources within a single carrier and across multiple carriers.

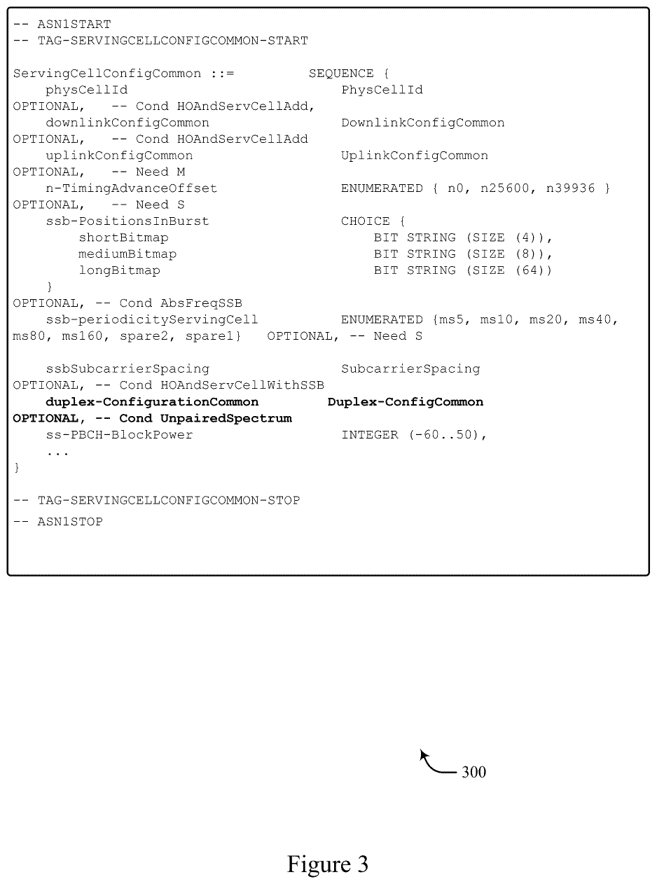

For example, as illustrated in FIG. 1, an NE 102 may transmit a carrier configuration 108 and a set of resource pattern configurations 110 to a UE 104 in a cell served by the NE 102 to configure how time and frequency resources are allocated for different types of communications. In some examples, the carrier configuration 108 and the set of resource pattern configurations 110 are transmitted via RRC signaling including one or more IEs, as described with reference to FIGS. 3 through 7, 9, 10A, and 10B. The carrier configuration 108 provides information regarding serving carriers associated with the UE 104. Each resource pattern configuration of the resource pattern configurations 110 is associated with a respective resource pattern and may specify or otherwise indicate a communication type (e.g., uplink, downlink, SBFD, flexible, or reserved) for the resource pattern, a periodicity at which the resource pattern repeats, and timing information identifying when resource occasions occur within the periodicity. For SBFD configurations, the resource pattern configuration may further specify or otherwise indicate frequency information, such as which RBs are allocated for uplink and downlink subbands.

A resource grid is a two-dimensional structure representing all available time-frequency resources for a carrier, where the frequency domain is divided into subcarriers grouped into RBs and the time domain is divided into symbols grouped into slots. A resource pattern defines a subset of the resource grid that is designated for a particular communication type (e.g., allocated for communications of the communications type) and that repeats according to a configured periodicity. Each resource pattern specifies timing information identifying when resource occasions occur within the periodicity, including a starting slot index, a starting symbol index, an ending slot index, and an ending symbol index. A resource occasion refers to an instance of the resource pattern within a single periodicity, comprising the time-frequency resources from the starting slot and symbol to the ending slot and symbol. For example, a downlink resource pattern with a periodicity of 5 ms, a starting slot index of 0, a starting symbol index of 0, an ending slot index of 2, and an ending symbol index of 13 indicates that slots 0 through 2 are available for downlink reception, and this pattern repeats every 5 ms. For SBFD resource patterns, the resource pattern further includes frequency information specifying the location and bandwidth of uplink and downlink subbands within the carrier.

The UE 104 uses the received resource pattern configurations 110 to determine when and how to transmit or receive on the configured resources. Based on the carrier configuration 108 and the resource pattern configurations 110, the UE 104 performs wireless communications 112 with the NE 102. Because each communication type can have its own resource pattern with an independent periodicity, the NE 102 can configure uplink, downlink, and full duplex resource occasions to occur at different rates, providing greater scheduling flexibility than conventional TDD configurations where uplink and downlink resources are tied to the same periodicity.

In contrast to conventional systems, each resource pattern configuration of the resource pattern configurations 110 is associated with a single communication type and indicates a periodicity for that communication type independent of other resource pattern configurations. In conventional tdd-UL-DL-ConfigurationCommon and tdd-UL-DL-ConfigurationDedicated configurations, the occurrence rates of uplink resource occasions and downlink resource occasions are the same because both are defined within a single resource pattern period. In the resource pattern configurations 110, the NE 102 may transmit, to a UE 104, a first resource pattern configuration associated with downlink communication having a first periodicity and a second resource pattern configuration associated with uplink communication having a second periodicity different from the first periodicity. This enables the NE 102 to configure uplink resource occasions to occur at a different rate than downlink resource occasions, providing flexibility that is not available in conventional bundled configurations.

The NE 102 may provide the resource pattern configurations 110 at the cell level, the UE level, or both. Cell-level configurations establish baseline resource patterns that apply to all UEs 104 within a cell and may be broadcast in system information or transmitted via dedicated signaling (e.g., RRC signaling). UE-level (i.e., UE-specific) configurations allow the NE 102 to tailor resource allocations for individual UEs or groups of UEs in the cell, based on factors such as traffic demands, UE capabilities (e.g., as indicated by the UE via UE capability signaling), UE location, or channel conditions. When the NE 102 provides both cell-level and UE-level configurations, the UE-level configuration supplements but does not contradict the cell-level configuration. For example, if the cell-level configuration designates a particular resource as downlink, the UE-level configuration cannot change that resource to uplink. If the UE 104 detects a conflict where a resource is indicated as one communication type by the cell-level configuration and a different communication type by the UE-level configuration, the UE 104 disregards the UE-level configuration for that resource and determines the communication type based on the cell-level configuration.

Additionally, or alternatively, the NE 102 may transmit a carrier configuration 108 that configures the UE 104 with multiple serving carriers and one or more resource pattern configurations 110 that apply across subsets of those serving carriers. Rather than configuring each serving carrier independently, the NE 102 can specify that a single resource pattern configuration applies to multiple serving carriers, reducing the amount of signaling required. The serving carriers associated with a resource pattern configuration may be in the same frequency band, different frequency bands, the same frequency range, or different frequency ranges. This flexibility allows the NE 102 to coordinate resource allocations across carriers with different propagation characteristics.

In conventional systems, activating or deactivating a serving carrier affects all communication types associated with that carrier. In contrast, the techniques described herein allow the NE 102 to independently activate or deactivate individual communication types for a serving carrier. For example, in paired spectrum, the NE 102 may activate or deactivate an uplink carrier independently from a downlink carrier. In unpaired spectrum, the NE 102 may activate or deactivate a set of uplink resource patterns independently from a set of downlink resource patterns for the same carrier. In either case, the NE 102 may transmit, to the UE 104, a cell activation/deactivation command (e.g., a cell activation/deactivation MAC-CE) that includes a respective pair of bit fields for each configured cell, where a first bit field of the pair indicates an activation status of a downlink carrier or a set of downlink resource patterns for the cell and a second bit field of the pair indicates an activation status of an uplink carrier or a set of uplink resource patterns for the cell. This uplink-downlink decoupling enables the NE 102 to optimize resource utilization based on a UE's location and channel conditions.

When the UE 104 is configured with multiple serving carriers via the carrier configuration 108 and multiple resource pattern configurations 110, the NE 102 may assign a priority to each resource pattern. If the UE 104 is not capable of performing simultaneous transmission and reception across all configured carriers (e.g., due to hardware limitations), the UE 104 uses the priority information to determine which scheduled communication to perform. For SBFD configurations that apply to multiple serving carriers with different bandwidths, the frequency information is defined based on the carrier with the smallest bandwidth, ensuring that the subband allocation fits within all associated carriers. For inter-carrier full duplex operation, where uplink and downlink occur simultaneously on different carriers rather than different subbands within the same carrier, the configuration specifies which carriers are designated for uplink and which are designated for downlink.

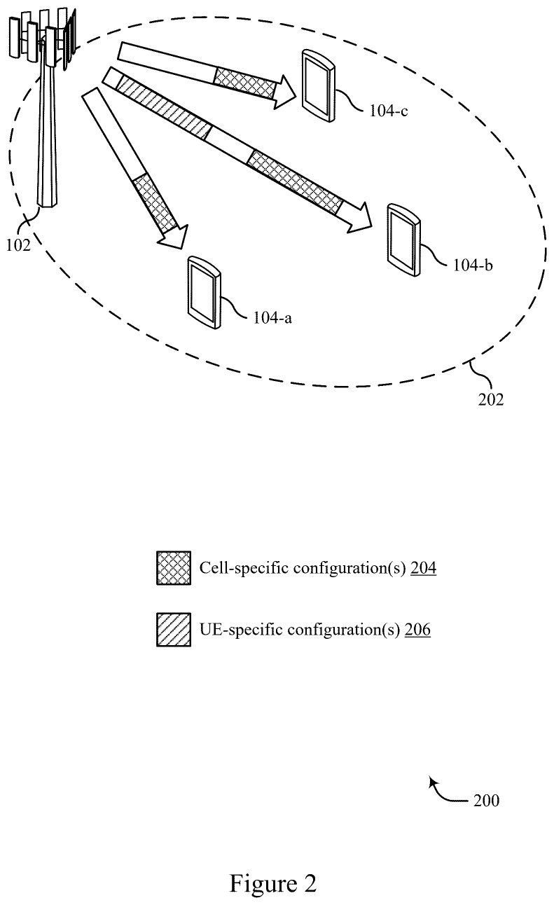

FIG. 2 illustrates an example of a wireless communications system 200 in accordance with aspects of the present disclosure. In some examples, the wireless communications system 200 implements or is implemented by aspects of the wireless communications system 100. The wireless communications system 200 may include an NE 102 and UEs 104-a, 104-b, and 104-c, which may be examples of an NE 102 and UEs 104 as described with reference to FIG. 1. The NE 102 serves the UEs 104 in a cell 202.

A carrier can be referred to or understood as a serving carrier, a CC, a cell, and/or a spectrum block. A carrier corresponds to a defined portion of spectrum that can be configured for different types of communications. In paired spectrum (e.g., FDD bands), separate uplink carriers and downlink carriers are paired together. In unpaired spectrum (e.g., TDD bands), a single carrier can be used for uplink, downlink, and SBFD or full duplex (FD) communications. A carrier may also be configured as uplink-only or downlink-only.

A cell (e.g., the cell 202) may be associated with different serving carrier configurations. A cell may include an uplink carrier and a downlink carrier in paired spectrum, an uplink-only carrier, a downlink-only carrier, a carrier configured for both uplink and downlink in unpaired spectrum, or a set of aggregated CCs (e.g., aggregated serving carriers). In CA, each serving carrier corresponds to a respective serving cell, such that the UE is configured with multiple serving cells. Aggregated serving carriers may have different relationships relative to each other. Inter-band serving carriers belong to different frequency bands. Intra-band contiguous serving carriers are adjacent in frequency within the same frequency band. Intra-band non-contiguous serving carriers are in the same frequency band but separated by a frequency gap. Serving carriers may also be in different frequency ranges (e.g., FR1 and FR2). The serving carriers in a subset of serving carriers associated with a resource pattern configuration may include any combination of these relationships.

The wireless communications system 200 illustrates resource pattern configurations for flexible duplexing within the cell 202 as described herein. For example, the NE 102 may transmit a set of resource pattern configurations to each of the UEs 104-a, 104-b, and 104-c to configure allocations of time and frequency resources for different types of communications. Each resource pattern configuration indicates (e.g., via a communication type field) a corresponding communication type (e.g., uplink, downlink, SBFD/FD, intra-serving carrier full duplex, inter-serving carrier full duplex, flexible, or reserved), a periodicity at which the resource pattern repeats, and timing information identifying when resource occasions occur within the periodicity. In some examples, each communication type may be allocated to a respective (e.g., separate) resource pattern with an independent periodicity, enabling the NE 102 to configure uplink, downlink, and full duplex resource occasions for each of the UEs 104 in the cell 202 with fine granularity.

In multi-carrier operation, the NE 102 may transmit one or more serving carrier configurations to each UE 104. A serving carrier configuration specifies a set of serving carriers associated with the UE 104 and the communication types supported by each serving carrier. The configuration indicates, for each serving carrier, whether the serving carrier supports uplink, downlink, full duplex, or a combination thereof. For example, a UE 104 may receive a configuration indicating a first serving carrier that supports downlink and SBFD, a second serving carrier that supports uplink only, and a third serving carrier that supports both uplink and downlink. Based on this configuration, the NE 102 can transmit resource pattern configurations that apply to subsets of the configured serving carriers and can transmit commands to activate or deactivate individual communication types for each serving carrier.

The serving carrier configurations and resource pattern configurations may be cell-specific, UE-specific, or both. Cell-specific configurations apply to all UEs 104 within the cell 202 and establish baseline parameters for serving carrier operation and resource allocation. UE-specific configurations apply to individual UEs 104 or groups of UEs 104 and enable the NE 102 to tailor configurations based on factors such as traffic demands, UE capabilities, UE location, or channel conditions. As illustrated in FIG. 2, the NE 102 transmits a cell-specific configuration 204 to the UEs 104-a, 104-b, and 104-c within the cell 202, and transmits a UE-specific configuration 206 to the UE 104-b. The cell-specific configuration 204 and the UE-specific configuration 206 may each include serving carrier configurations, resource pattern configurations, or both.

The serving carrier configurations and resource pattern configurations may be transmitted via RRC signaling using one or more IEs as described herein. Cell-specific configurations may be indicated using a ServingCellConfigCommon IE, which includes a Duplex-ConfigCommon IE for cell-specific resource patterns and an SCS-SpecificCarrier IE for carrier-specific parameters including SBFD subband allocations. UE-specific configurations may be indicated using a ServingCellConfig IE, which includes a Duplex-ConfigDedicated IE for UE-specific resource patterns. For multi-carrier operation, the NE 102 may transmit a MultiCellConfig IE to configure multiple aggregated serving cells, and a PhysicalMultiCellConfig IE to configure resource patterns that apply across subsets of serving carriers.

For example, the NE 102 may transmit a serving carrier configuration to the UEs 104-a, 104-b, and 104-c to configure them with a set of serving carriers. The serving carrier configuration may indicate the respective communication type(s) supported by each serving carrier. The NE 102 may further transmit, to the UEs 104, a set of resource pattern configurations that apply across one or more subsets of the set of serving carriers. Rather than configuring resources for each serving carrier independently, the NE 102 may specify that a single resource pattern configuration applies to multiple serving carriers, thereby reducing signaling overhead. For example, a resource pattern configuration may indicate the subset of serving carriers to which the resource pattern configuration applies. The serving carriers in the subset may be intra-band, inter-band, in a same frequency range, or in different frequency ranges relative to each other.

As another example, a first set of resource patterns may be cell-specifically configured (e.g., via duplex-ConfigurationCommon) via system information and/or dedicated RRC signaling, and a second set of resource patterns is UE-specifically configured (e.g., via duplex-ConfigurationDedicated) via dedicated RRC signaling. The resource pattern configuration may be cell-specific when multiple serving carriers are cell-specifically configured for the cell 202, or UE-specific when multiple serving carriers are UE-specifically configured for a UE 104. In some cases, even when the serving carrier configuration is cell-specific, the resource pattern configuration may be UE-specific or UE-group specific based on UE measurement results and/or UE capability information. For example, if a UE 104's measurement value on a particular serving carrier is less than a threshold value, the NE 102 may not configure an uplink resource pattern associated with that serving carrier for the UE 104. In another example, if UE capability information indicates full-duplex capability across a subset of serving carriers, an inter-serving carrier FD resource pattern for the subset of serving carriers may be configured for the UE 104. In another example, the NE 102 may configure a UE 104 with UE-specific resource patterns to provide additional uplink resources when the UE 104 handles uplink-heavy applications.

Additionally, or alternatively, a group of UEs 104 may share a same UE-specific configuration. For example, UE 104-a and UE 104-b may receive the same UE-specific configuration 206 if they have similar traffic patterns, are located in similar positions within the cell 202, or have similar UE capabilities. The assignment of a UE-specific configuration to a single UE 104 or a group of UEs 104 is based on NE implementation.

In some examples, if the NE 102 does not configure a resource pattern for a particular communication type, the serving carrier supports only the configured communication types. For example, if a serving carrier is configured with only a resource pattern associated with downlink communication, the serving carrier supports downlink communication only.

In other examples, if the NE 102 does not configure any resource pattern for any communication type, the serving carrier supports only a predefined or default communication type. For example, if a serving carrier is not configured with any resource pattern but is predefined as downlink spectrum, the serving carrier supports downlink communication only.

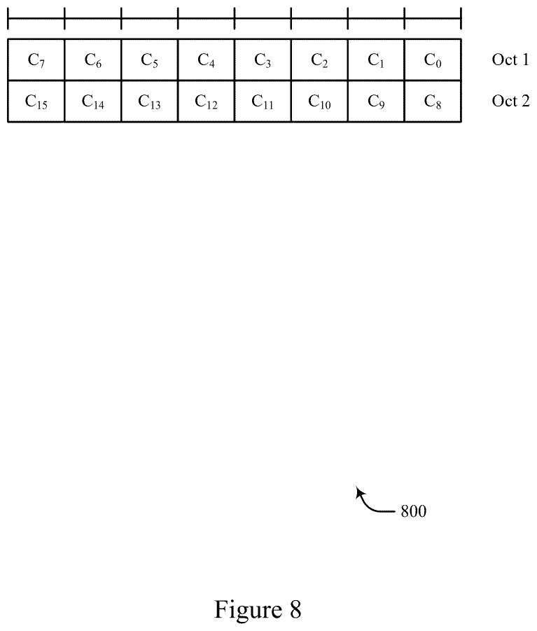

The NE 102 may transmit a command (e.g., a cell activation/deactivation MAC-CE as described with reference to FIG. 8) to activate or deactivate individual communication types for a serving carrier. In paired spectrum, the command may activate or deactivate an uplink carrier or a downlink carrier independently. In unpaired spectrum, the command may activate or deactivate a set of uplink resource patterns or a set of downlink resource patterns independently. As an example, the NE 102 may transmit, to a UE 104, a cell activation/deactivation MAC-CE that includes a respective pair of bit fields for each configured serving carrier, where a first bit field of the pair indicates an activation status of a downlink carrier or a set of downlink resource patterns for the serving carrier and a second bit field of the pair indicates an activation status of an uplink carrier or a set of uplink resource patterns for the serving carrier. This uplink-downlink decoupling enables the NE 102 to optimize resource utilization based on each UE 104's location and channel conditions. For example, a serving carrier in a higher frequency band (e.g., 3.5 GHZ) may provide favorable downlink coverage due to higher network transmit power, while a serving carrier in a lower frequency band (e.g., 800 MHz) may provide favorable uplink coverage due to reduced signal attenuation and improved link budget for devices with limited transmit power.

Each resource pattern configuration includes timing information identifying when resource occasions occur within the periodicity. The timing information may be specified in different formats. In one implementation, the timing information includes a starting slot index, a starting symbol index, an ending slot index, and an ending symbol index. In another implementation, the timing information includes a starting symbol index, an ending symbol index, and a slot-level start and length indicator value (SSLIV). The number of consecutive slots L counting from a starting slot S allocated for a full duplex subband is determined as follows:

$$if ( L - 1 ) \leq ⌊ {N}_{slot , Max} / 2 ⌋$$

$$then$$

$$SSLIV = {N}_{slot , Max} \cdot ( L - 1 ) + S$$

$$else$$

$$SSLIV = {N}_{slot , Max} \cdot ( {N}_{slot , Max} - L + 1 ) + ( {N}_{slot , Max} - 1 - S )$$

where N_{slot,Max} is the maximum number of slots and 0<L≤N_{slot,Max}−S.

The periodicity may be configured such that 20 milliseconds is divisible by the periodicity of the resource pattern, providing a common reference for each resource pattern.

For a given communication type, the NE 102 may configure multiple resource patterns that each have a different periodicity and/or different timing information. Because each resource pattern is associated with a single communication type and indicates an independent periodicity, the NE 102 can tailor the rate at which resource occasions occur for each communication type within the cell 202. In conventional systems using tdd-UL-DL-ConfigurationCommon or tdd-UL-DL-ConfigurationDedicated, uplink, downlink, and flexible resources share a common periodicity and are configured together as a set, constraining the network to allocate uplink and downlink resource occasions at the same rate. In the wireless communications system 200, the NE 102 may configure downlink resource occasions to occur every 5 ms while configuring uplink resource occasions to occur every 10 ms, or vice versa, based on traffic demands within the cell 202. This per-communication-type configuration with independent periodicities enables the NE 102 to optimize resource allocation for scenarios where uplink and downlink traffic demands differ. For example, the NE 102 may configure a first uplink resource pattern with a periodicity of 5 ms and a second uplink resource pattern with a periodicity of 10 ms, enabling uplink resource occasions to occur at varying rates. This enables certain resource occasions to occur more frequently than other resource occasions for the same communication type, allowing the NE 102 to flexibly tailor resource allocations for a particular scenario.

For resource pattern configurations associated with SBFD, the configuration includes frequency information indicating which RBs are allocated for uplink and downlink subbands. The frequency information may comprise an RIV for at least an uplink subband. The RIV corresponding to a starting RB RBₛₜₐᵣₜ and a length in terms of contiguously allocated RBs L_{RBs} is defined by:

$$if ( {L}_{RBs} - 1 ) \leq ⌊ {N}_{c}^{size} / 2 ⌋$$

$$then$$

$$RIV = {N}_{c}^{size} ( {L}_{RBs} - 1 ) + {RB}_{start}$$

$$else$$

$$RIV = {N}_{c}^{size} ( {N}_{c}^{size} - {L}_{RBs} + 1 ) + ( {N}_{c}^{size} - 1 - {RB}_{start} ) ,$$

$$where {N}_{c}^{size}$$

denotes a number of resource blocks in a carrier c, and L_{RBs}≥1 and shall not exceed

$${N}_{c}^{size} - {RB}_{start} .$$

For SBFD configurations that apply to multiple serving carriers with different bandwidths, the RIV is defined based on a quantity of RBs corresponding to a minimum bandwidth among the subset of serving carriers. This ensures that the subband allocation fits within all associated serving carriers. For example, if a first serving carrier has 50 RBs and a second serving carrier has 75 RBs, and the configuration indicates that the first 30 RBs are for downlink and the remaining RBs are for uplink, the RIV is calculated based on the 50 RB serving carrier. The UE 104 applies the same RIV to both serving carriers, such that the first serving carrier has 30 RBs for downlink and 20 RBs for uplink, while the second serving carrier has 30 RBs for downlink and 45 RBs for uplink. For intra-serving carrier SBFD configurations, in one implementation, each serving carrier of the indicated one or more serving carriers has separate frequency information for the at least one resource occasion, providing separate subband configurations per serving carrier. In another implementation, the same RIV is applicable to all indicated serving carriers. For inter-serving carrier full duplex operation, where uplink and downlink occur simultaneously on different serving carriers rather than on different subbands within the same serving carrier, the frequency information indicates a first set of serving carriers configured for uplink and a second set of serving carriers configured for downlink.

When the NE 102 provides a UE 104 with both a cell-specific configuration 204 and a UE-specific configuration 206, the UE-specific configuration 206 supplements but does not contradict the cell-specific configuration 204. For example, the UE 104 does not expect duplex-ConfigurationDedicated to indicate as uplink or as downlink a symbol that duplex-ConfigurationCommon indicates as a downlink symbol or as an uplink symbol, respectively. The UE 104 does not expect duplex-ConfigurationDedicated to indicate as SBFD a symbol that duplex-ConfigurationCommon indicates as a downlink symbol or as an uplink symbol. The UE 104 considers symbols in a slot indicated as downlink by duplex-ConfigurationCommon or duplex-ConfigurationDedicated to be available for reception and considers symbols in a slot indicated as uplink by duplex-ConfigurationCommon or duplex-ConfigurationDedicated to be available for transmission. The UE 104 considers a downlink subband in an SBFD symbol indicated by duplex-ConfigurationCommon or duplex-ConfigurationDedicated to be available for reception and considers an uplink subband in an SBFD symbol indicated by duplex-ConfigurationCommon or duplex-ConfigurationDedicated to be available for transmission.

For a resource pattern configuration associated with a flexible communication type, the communication direction (uplink or downlink) is not predetermined by the resource pattern configuration. Instead, the communication direction is determined based on a dynamic indication, a semi-static resource configuration of a physical channel, or a semi-static resource configuration of a physical signal. A dynamic indication may include or be an example of DCI that schedules a PDSCH or PUSCH transmission in the flexible resources, thereby indicating the communication direction for those resources. A semi-static resource configuration of a physical channel may include or be an example of a configured grant for PUSCH or a semi-persistent scheduling configuration for PDSCH, where the UE 104 is configured with periodic resources for uplink transmission or downlink reception, respectively. A semi-static resource configuration of a physical signal may include or be an example of a configured sounding reference signal (SRS) resource for uplink or a configured channel state information-reference signal (CSI-RS) resource for downlink, where the presence of the configured signal resource determines the communication direction for the associated resources.

For a resource pattern configuration associated with a reserved communication type, the resources indicated by the resource pattern configuration are unavailable for the UE 104. The reserved resource pattern may be used for other purposes, such as deployment for IoT devices.

Resources that are not included in any configured resource pattern (e.g., remaining resources of the resource grid) may be treated as unavailable or as flexible. In one implementation, the UE 104 assumes that resources not included in any resource pattern configuration are unavailable. Additionally, or alternatively the NE 102 may transmit an indication to the UE 104 indicating that such resources are unavailable. In another implementation, the UE 104 assumes and/or receives an indication that resources not included in any resource pattern configuration are flexible, and the communication type for the unconfigured resources is determined based on a dynamic indication (e.g., DCI) or a semi-static resource configuration of a physical channel or physical signal (e.g., SRS, CSI-RS). In this case, no specific flexible resource pattern is configured, and any resources not included in the downlink, uplink, or SBFD resource patterns are considered as flexible symbols.

Additionally, or alternatively, serving carriers that are not associated with any configured resource pattern configuration may be treated as unavailable or as flexible. In one implementation, the UE 104 receives an indication via RRC signaling that a serving carrier not associated with any resource pattern configuration is unavailable and/or deactivated (e.g., indefinitely or for an indicated or preconfigured time duration). In another implementation, a communication type for a serving carrier not associated with any resource pattern configuration may be determined by the UE 104 based on a dynamic indication (e.g., DCI), a semi-static resource configuration of a physical channel, or a semi-static resource configuration of a physical signal. This enables the NE 102 to reserve unconfigured serving carriers for future configuration or to allow their use based on dynamic scheduling decisions. In other implementations, a communication type for a serving carrier not associated with any resource pattern configuration may be determined based on a predefined or default communication type for the serving carrier.

In some examples, the NE 102 may release a resource pattern that was previously configured for a UE 104, such as by transmitting a release or modification indication via RRC signaling. Each resource pattern includes an indication of a respective resource pattern identity that enables the resource pattern to be addressed for modification or release. When a resource pattern is released, the communication type of the resources (e.g., slots, symbols, or subframes) previously associated with that resource pattern may change to a different communication type. The new communication type may be determined by a dynamic indication (e.g., DCI) or a semi-static resource configuration for a physical channel or reference signal. A UE 104 does not expect the communication type of a symbol, slot, or subframe determined by a resource pattern to change by a dynamic indication or a semi-static downlink/uplink channel or reference signal resource configuration unless the resource pattern is released. While a resource pattern remains configured, the communication type specified by that resource pattern takes precedence over other indications. The resource pattern provides a guaranteed downlink symbol, a guaranteed uplink symbol, or a flexible symbol as configured.

Certain resources are protected from conflicting configurations. A resource pattern configured for uplink communications does not overlap with a first set of resources indicated to the UE 104 for reception of one or more synchronization signal blocks (SSBs) and does not overlap with a second set of resources corresponding to a CORESET for reception of system information (e.g., system information block type 1 (SIB1)). The SSB and CORESET for SIB1 reception are essential downlink signals and channels for cell discovery, and these resources are protected. If the NE 102 configures an uplink resource pattern that overlaps with SSB or CORESET resources, the UE 104 considers this an error case because the UE 104 prioritizes reception of the SSB and the CORESET for system information delivery. A resource pattern configured for downlink communications does not overlap with one or more valid PRACH occasions where the UE 104 can transmit PRACH preambles. The UE 104 does not receive downlink signals and/or channels except for SS/PBCH blocks for N_{gap} symbols before a valid PRACH occasion.

When a UE 104 receives DCI scheduling a PDSCH over a set of slots, some of the scheduled slots may correspond to an uplink resource pattern or an uplink subband of an SBFD resource pattern. For example, the NE 102 may schedule a PDSCH transmission spanning multiple slots for coverage enhancement or improved reliability, but one or more of those slots may be configured as uplink slots or may include an uplink subband in an SBFD configuration. In this case, the UE 104 skips reception of the PDSCH in those slots because the resource pattern configuration designates those resources for uplink transmission rather than downlink reception. The UE 104 continues to receive the PDSCH in the remaining slots of the set of slots that correspond to downlink resources. Similarly, when a UE 104 receives DCI scheduling a PUSCH over a set of slots, some of the scheduled slots may correspond to a downlink resource pattern or a downlink subband of an SBFD resource pattern. For example, the NE 102 may schedule a PUSCH transmission spanning multiple slots for coverage enhancement, but one or more of those slots may be configured as downlink slots or may include a downlink subband in an SBFD configuration. In this case, the UE 104 skips transmission of the PUSCH in those slots because the resource pattern configuration designates those resources for downlink reception rather than uplink transmission. The UE 104 continues to transmit the PUSCH in the remaining slots of the set of slots that correspond to uplink resources.

In an SBFD symbol, if a UE 104 is not capable of SBFD communication and a PRACH transmission and a downlink reception are scheduled in overlapping resources, the UE 104 selects whether to transmit the PRACH or receive the downlink signal or channel. For example, a UE 104 that does not support simultaneous transmission and reception within a single serving carrier may be configured with an SBFD resource pattern where an uplink subband overlaps with a PRACH occasion and a downlink subband overlaps with a scheduled PDSCH or PDCCH reception. Because the UE 104 cannot perform both operations simultaneously, the UE 104 determines which operation to perform. The selection is based on UE implementation and may depend on factors such as the priority of the downlink reception, the urgency of the random access procedure, or other UE-specific considerations.

When a UE 104 is configured with multiple serving carriers and multiple resource pattern configurations, each resource pattern configuration may include a priority indication for the corresponding resource pattern. The priority indicates a ranking among all configured resource patterns across all configured serving carriers. If the UE 104 cannot perform simultaneous transmission and reception across all configured serving carriers (e.g., due to capability or hardware limitations), the UE 104 uses the priority information to determine which scheduled communication to perform. For example, the UE 104 may prioritize a communication scheduled in a higher priority resource pattern based on the UE 104's capability. The UE 104 may report its carrier capability to the NE 102, and the NE 102 configures resource patterns based on the reported UE capability and NE capability. If a UE 104 is capable of simultaneous transmission and reception across all configured serving carriers, the priority information may not be used. When first and second resource patterns have an equal priority and semi-statically configured communications (semi-persistent scheduling (SPS) PDSCH) in the first resource pattern collide with dynamically scheduled communications (dynamic PUSCH) in the second resource pattern, the UE may perform the dynamically scheduled communications. When communications scheduled in different resource patterns of different priorities collide, the priority information provides a rule for both the NE 102 and the UE 104 to determine which communication to perform.

Certain communications may take precedence regardless of the configured priority. For example, if the UE 104 is scheduled to receive an SSB on a serving carrier, the UE 104 prioritizes SSB reception over other transmissions, irrespective of the priority of the associated resource patterns. SSB reception is essential for cell synchronization and measurement and thus may be maintained even when other communications are scheduled in higher priority resource patterns.

FIG. 3 illustrates an IE 300 used to configure cell-specific parameters of a serving cell, in accordance with aspects of the present disclosure. In some examples, the IE 300 implements or is implemented by aspects of the wireless communications system 100 and/or the wireless communications system 200. For example, an (e.g., an NE 102) may transmit, to a UE (e.g., a UE 104), a serving cell configuration that includes the IE 300 to configure a serving cell of the UE (e.g., the cell 202 as described with reference to FIG. 2). The IE 300 may be defined as a ServingCellConfigCommon IE.

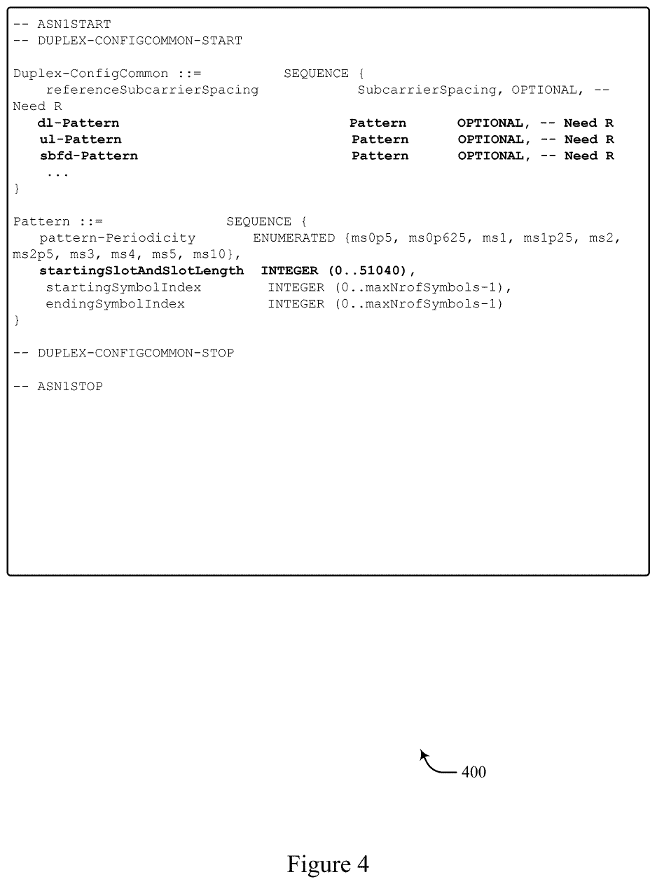

The NE 102 transmits the ServingCellConfigCommon information element to the UE 104 via RRC signaling to establish cell-specific parameters for the serving cell. The ServingCellConfigCommon information element provides common configuration parameters that apply to all UEs within the cell, including downlink and uplink configuration, SSB positioning and periodicity, and duplex configuration for flexible duplexing. The ServingCellConfigCommon information element includes a duplex-ConfigurationCommon field that provides cell-specific resource pattern configurations for uplink, downlink, and SBFD communications, as described with reference to FIG. 4. The following Table 1 provides field descriptions for the ServingCellConfigCommon IE.

TABLE 1
ServingCellConfigCommon field descriptions

downlinkConfigCommon
The common downlink configuration of the serving cell, including the frequency information configuration and the initial
downlink BWP common configuration.
uplinkConfigCommon
The common uplink configuration of the serving cell, including the initial uplink BWP common configuration.
longBitmap
Bitmap when maximum number of SS/PBCH blocks per half frame equals to 64.
mediumBitmap
Bitmap when maximum number of SS/PBCH blocks per half frame equals to 8.
n-TimingAdvanceOffset
A timing advance offset to be applied for all uplink transmissions on this serving cell.
If the field is absent, the UE applies a pre-defined value for the duplex mode and frequency range of this serving cell.
shortBitmap
Bitmap when maximum number of SS/PBCH blocks per half frame equals to 4.
ss-PBCH-BlockPower
Average EPRE of the resources elements that carry secondary synchronization signals in dBm that the NW used for
SSB transmission.
ssb-periodicityServingCell
The SSB periodicity in ms for the rate matching purpose. If the field is absent, the UE applies the value ms 20.
ssb-PositionsInBurst
Indicates the time domain positions of the transmitted SS-blocks in a half frame with SS/PBCH blocks. The
first/leftmost bit corresponds to SS/PBCH block index 0, the second bit corresponds to SS/PBCH block index 1, and
so on. Value 0 in the bitmap indicates that the corresponding SS/PBCH block is not transmitted while value 1 indicates
that the corresponding SS/PBCH block is transmitted. The network configures the same pattern in this field as in the
corresponding field in ServingCellConfigCommonSIB.
ssbSubcarrierSpacing
Subcarrier spacing of SSB.
Only the following values are applicable depending on the used frequency:
FR1: 15 or 30 kHz
FR2-1/FR2-NTN: 120 or 240 kHz
FR2-2: 120, 480, or 960 kHz
duplex-ConfigurationCommon
Cell-specific DL, UL, and/or SBFD resource configurations.

FIG. 4 illustrates an IE 400 used to indicate cell-specific or carrier-specific uplink, downlink, and SBFD resource configurations. In some examples, the IE 400 implements or is implemented by aspects of the wireless communications system 100 and/or the wireless communications system 200. For example, an NE (e.g., an NE 102) may transmit, to a UE (e.g., a UE 104), a duplex configuration that includes the IE 400 to configure resource patterns for different communication types within a serving cell of the UE (e.g., the cell 202 as described with reference to FIG. 2). The IE 400 may be defined as a Duplex-ConfigCommon IE.

The Duplex-ConfigCommon IE is included within the ServingCellConfigCommon IE as described with reference to FIG. 3 and provides cell-specific resource pattern configurations that apply to all UEs within a cell. The NE transmits the Duplex-ConfigCommon information element to the UE via system information or dedicated signaling to establish resource patterns for different communication types within the serving cell, where each resource pattern has an independent periodicity and timing configuration.

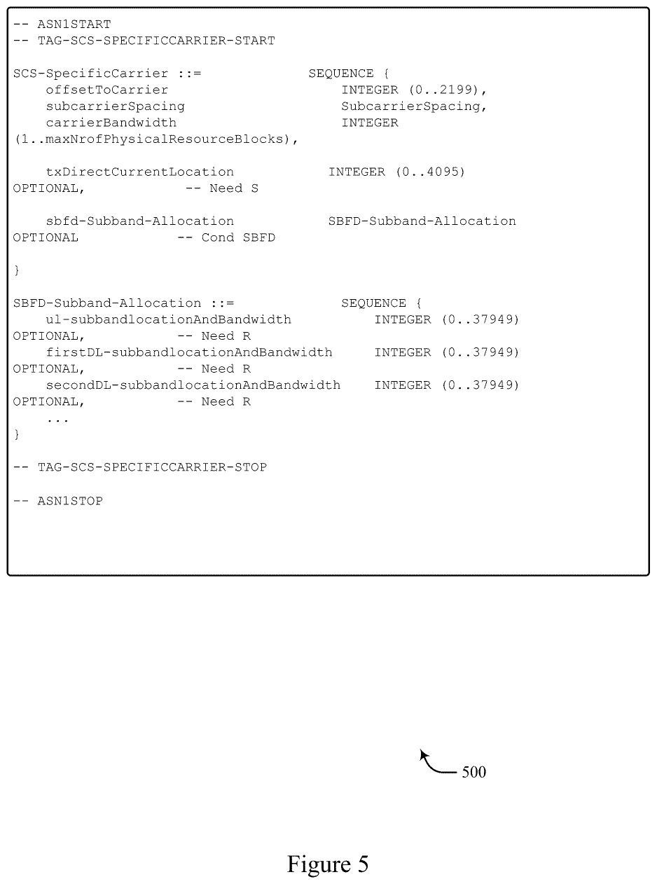

The UE considers symbols in a slot indicated as downlink by the Duplex-ConfigCommon IE to be available for reception and considers symbols in a slot indicated as uplink to be available for transmission. For SBFD patterns, the UE considers a downlink subband in an SBFD symbol to be available for reception and considers an uplink subband in an SBFD symbol to be available for transmission. The frequency information for subband allocations in cell-specific configurations is provided in the SCS-SpecificCarrier IE, as described with reference to FIG. 5.

The following Tables 2 and 3 provide field descriptions for the Duplex-ConfigCommon IE.

TABLE 2
Duplex-ConfigCommon field descriptions

referenceSubcarrierSpacing
Reference SCS used to determine time domain boundaries in UL/DL/SBFD patterns which must be common across
all subcarrier specific carriers, i.e., independent of the actual subcarrier spacing using for data transmission.
Only the following values are applicable depending on the used frequency:
FR1: 15 or 30 kHz
FR2-1: 60 or 120 kHz
FR2-2: 120, 480, or 960 kHz

TABLE 3
Pattern field descriptions

pattern-Periodicity
Periodicity of a DL/UL/SBFD pattern. The periodicity, P, divides 20 ms. The first symbol every (20/P) periods is a first
symbol in an even frame.
startingSlotAndSlotLength
Determines a starting slot index and a slot length for a DL/UL/SBFD resource occasion within a DL/UL/SBFD pattern
period.
startingSymbolIndex, endingSymbolIndex
Configures a starting symbol index within a starting slot, an ending symbol index within an ending slot of a
DL/UL/SBFD pattern within a DL/UL/SBFD pattern period.

FIG. 5 illustrates an IE 500 used to configure parameters determining a location and a width of a carrier or carrier bandwidth, in accordance with aspects of the present disclosure. In some examples, the IE 500 implements or is implemented by aspects of the wireless communications system 100 and/or the wireless communications system 200. For example, an (e.g., an NE 102) may transmit, to a UE (e.g., a UE 104), a carrier configuration that includes the IE 500 to configure subcarrier spacing specific parameters and SBFD subband allocations for a serving carrier of the UE. The IE 500 may be defined as an SCS-SpecificCarrier IE.

The NE 102 transmits the SCS-SpecificCarrier information element to the UE 104 via RRC signaling to establish carrier-specific parameters for the serving cell. The SCS-SpecificCarrier information element provides frequency domain parameters for a carrier, including a carrier location, a carrier bandwidth, and subband allocations for SBFD operation. The SCS-SpecificCarrier information element is included within the downlink or uplink configuration of the serving cell and works in conjunction with the Duplex-ConfigCommon information element to define both time domain and frequency domain resources for flexible duplexing.

The SCS-SpecificCarrier IE configures parameters determining a location and a width of a carrier or carrier bandwidth. The SCS-SpecificCarrier IE is defined specifically for a numerology, identified by an SCS, and in relation to Point A, which corresponds to a lowest subcarrier of common RB 0. The SCS-SpecificCarrier IE includes an sbfd-Subband-Allocation field of type SBFD-Subband-Allocation that is optional and conditional on SBFD configuration. The sbfd-Subband-Allocation field provides frequency domain configuration for SBFD operation, specifying the location and bandwidth of uplink and downlink subbands within the carrier.

The SCS-SpecificCarrier IE, when included in the downlink or uplink configuration of a serving cell, provides carrier-specific parameters that define the frequency domain structure of the carrier. For SBFD operation, the SBFD-Subband-Allocation field works in conjunction with the sbfd-Pattern field in the Duplex-ConfigCommon IE to define both time domain and frequency domain resources for SBFD communication. The UE 104 uses the configured subband allocations to determine which RBs are available for uplink transmission and which RBs are available for downlink reception during SBFD symbols. The following Tables 4 and 5 provide field descriptions for the SCS-SpecificCarrier IE and the SBFD-Subband-Allocation sequence.

TABLE 4
SCS-SpecificCarrier field descriptions

carrierBandwidth
Width of this carrier in number of PRBs (using the subcarrierSpacing defined for this carrier). For the case that
12PRB/20 PRB transmission bandwidth is used, the network configures the carrierBandwidth to 15 PRB (for the 12
PRB case) and 25 PRB (for the 20 PRB case), respectively, and the UE uses 12PRB/20 PRB as the transmission
bandwidth, respectively.
offsetToCarrier
Offset in frequency domain between Point A (lowest subcarrier of common RB 0) and the lowest usable subcarrier on
this carrier in number of PRBs (using the subcarrierSpacing defined for this carrier). The maximum value corresponds
to 275*8-1.
txDirectCurrentLocation
Indicates the downlink Tx Direct Current location for the carrier. A value in the range 0 . . . 3299 indicates the subcarrier
index within the carrier. The values in the value range 3301 . . . 4095 are reserved and ignored by the UE. If this field is
absent for downlink within ServingCellConfigCommon and ServingCellConfigCommonSIB, the UE assumes the
default value of 3300 (i.e. “Outside the carrier”).
subcarrierSpacing
Subcarrier spacing of this carrier. It is used to convert the offsetToCarrier into an actual frequency.
Only the following values are applicable depending on the used frequency:
FR1: 15 or 30 kHz
FR2-1/FR2-NTN: 60 or 120 kHz
FR2-2: 120, 480, or 960 kHz

TABLE 5
SBFD-Subband-Allocation field descriptions

firstDL-subbandlocationAndBandwidth
Configures frequency domain location and bandwidth of the first DL subband. The value of the field is interpreted as a
resource indicator value (RIV).
secondDL-subbandlocationAndBandwidth
Configures frequency domain location and bandwidth of the second DL subband. The value of the field is interpreted
as a resource indicator value (RIV).
ul-subbandlocationAndBandwidth
Configures frequency domain location and bandwidth of an UL subband. The value of the field is interpreted as a
resource indicator value (RIV).

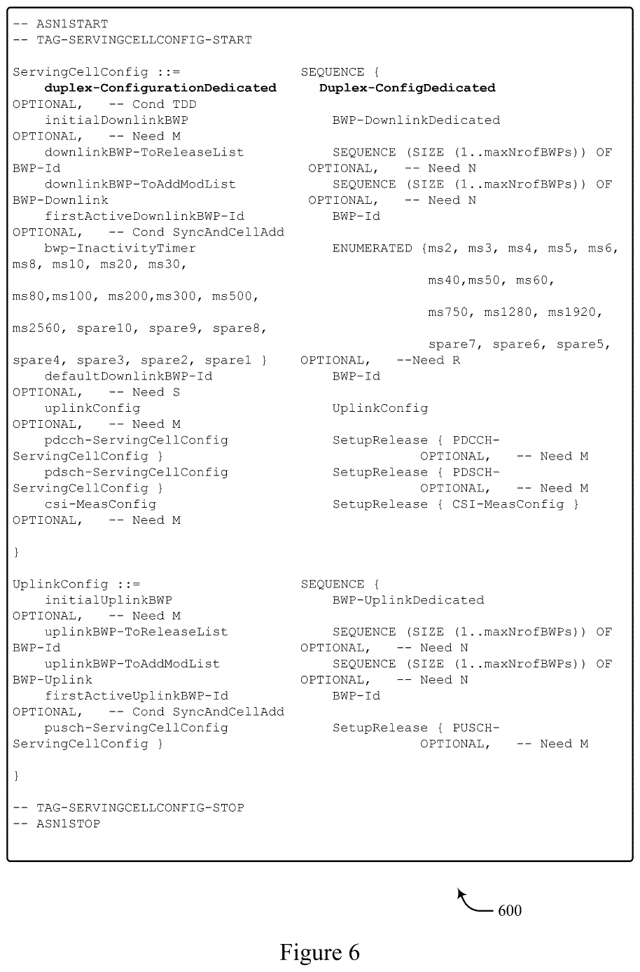

FIG. 6 illustrates an IE 600 used to configure a UE with a serving cell, in accordance with aspects of the present disclosure. In some examples, the IE 600 implements or is implemented by aspects of the wireless communications system 100 and/or the wireless communications system 200. For example, an (e.g., an NE 102) may transmit, to a UE (e.g., a UE 104), a serving cell configuration that includes the IE 600 to configure UE-specific parameters for a serving cell of the UE (e.g., the cell 202 as described with reference to FIG. 2). The IE 600 may be defined as a ServingCellConfig IE

The ServingCellConfig IE is used to configure UE-specific parameters for a serving cell. The NE 102 transmits the ServingCellConfig IE to the UE 104 via dedicated RRC signaling to establish UE-specific parameters for the serving cell, including BWP configurations, physical channel configurations, and duplex configuration for UE-specific resource patterns. The parameters in the ServingCellConfig IE are mostly UE-specific but partly also cell-specific, such as in additionally configured BWPs.

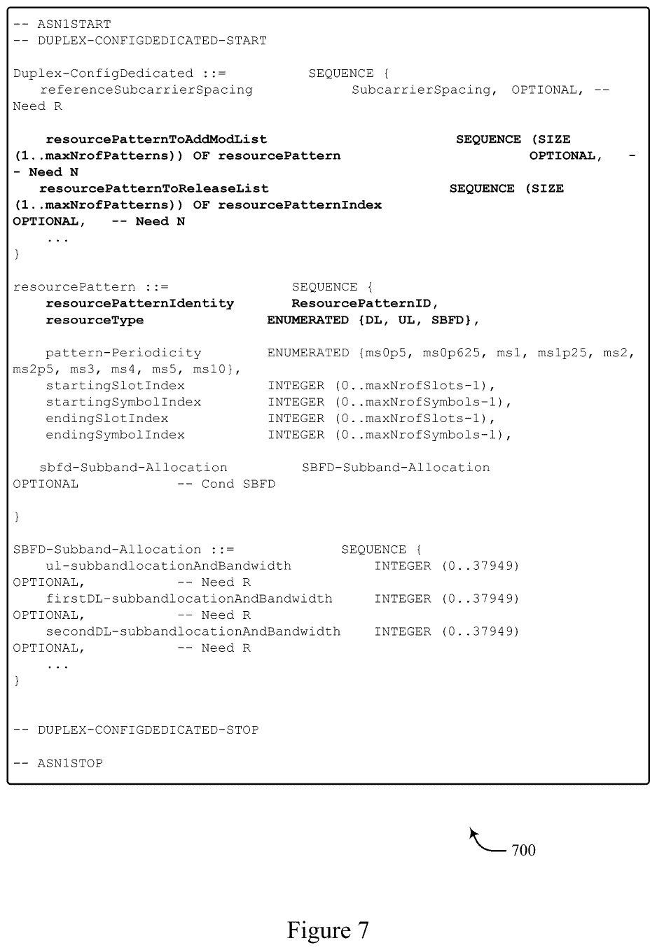

The ServingCellConfig IE includes a duplex-ConfigurationDedicated field of type Duplex-ConfigDedicated that provides UE-specific or UE group-specific uplink, downlink, and SBFD resource configurations. The duplex-ConfigurationDedicated field is conditionally present for TDD cells and enables the NE 102 to configure additional resource patterns for individual UEs or groups of UEs beyond the cell-specific resource patterns configured in the Duplex-ConfigCommon IE. The UE-specific resource patterns configured via the duplex-ConfigurationDedicated field supplement but do not contradict the cell-specific resource patterns. The UE 104 does not expect the duplex-ConfigurationDedicated field to indicate as uplink or as downlink a symbol that the duplex-ConfigurationCommon field indicates as a downlink symbol or as an uplink symbol, respectively. The structure of the Duplex-ConfigDedicated IE is described with reference to FIG. 7.

The ServingCellConfig IE includes an uplinkConfig field of type UplinkConfig that provides UE-specific uplink configuration parameters. This hierarchical configuration approach enables the NE 102 to establish baseline resource patterns for all UEs in a cell while providing additional resources to individual UEs or groups of UEs based on factors such as traffic demands, UE location, or channel conditions. The following Table 6 provides field descriptions for the ServingCellConfig IE.

TABLE 6
ServingCellConfig field descriptions

bwp-InactivityTimer
The duration in ms after which the UE falls back to the default Bandwidth Part. When the network releases the timer
configuration, the UE stops the timer without switching to the default BWP.
defaultDownlinkBWP-Id
The initial bandwidth part is referred to by BWP-Id = 0. ID of the downlink bandwidth part to be used upon expiry of the
BWP inactivity timer. This field is UE specific. When the field is absent the UE uses the initial BWP as default BWP.
(see TS 38.213 [13], clause 12 and TS 38.321 [3], clause 5.15).
downlinkBWP-ToAddModList
List of additional downlink bandwidth parts to be added or modified. (see TS 38.213 [13], clause 12).
downlinkBWP-ToReleaseList
List of additional downlink bandwidth parts to be released. (see TS 38.213 [13], clause 12).
firstActiveDownlinkBWP-Id
If configured for an SpCell, this field contains the ID of the DL BWP to be activated or to be used for RLM, BFD and
measurements if included in an RRCReconfiguration message contained in an NR or E-UTRA RRC message
indicating that the SCG is deactivated, upon performing the RRC (re-)configuration. If the field is absent, the RRC
(re-)configuration does not impose a BWP switch. If the field is absent for the PSCell at SCG deactivation, the UE
considers the previously activated DL BWP as the BWP to be used for RLM, BFD and measurements. If the field is
absent for the PSCell at SCG activation, the DL BWP to be activated is the DL BWP previously to be used for RLM,
BFD and measurements.
If configured for an SCell, this field contains the ID of the downlink bandwidth part to be used upon activation of an
SCell. The initial bandwidth part is referred to by BWP-Id = 0.
Upon reconfiguration with reconfigurationWithSync, the network sets the firstActiveDownlinkBWP-Id and
firstActiveUplinkBWP-Id to the same value.
initialDownlinkBWP
The dedicated (UE-specific) configuration for the initial downlink bandwidth-part (i.e., DL BWP#0). If any of the
optional IEs are configured within this IE, the UE considers the BWP#0 to be an RRC configured BWP (from UE
capability viewpoint). Otherwise, the UE does not consider the BWP#0 as an RRC configured BWP (from UE
capability viewpoint). Network always configures the UE with a value for this field if no other BWPs are configured.
NOTE1
pdsch-ServingCellConfig
PDSCH related parameters that are not BWP-specific.
uplinkConfig
Network may configure this field only when uplinkConfigCommon is configured in ServingCellConfigCommon or
ServingCellConfigCommonSIB. Addition or release of this field can only be done upon SCell addition or release
(respectively).

FIG. 7 illustrates an IE 700 used to configure UE-specific or UE group-specific uplink, downlink, and SBFD resource configurations, in accordance with aspects of the present disclosure. In some examples, the IE 700 implements or is implemented by aspects of the wireless communications system 100 and/or the wireless communications system 200. For example, an NE (e.g., an NE 102) may transmit, to a UE (e.g., a UE 104), a dedicated duplex configuration that includes the IE 700 to configure resource patterns for different communication types specific to the UE or a group of UEs within a serving cell (e.g., the cell 202 as described with reference to FIG. 2). The IE 700 may be defined as a Duplex-ConfigDedicated IE.

The Duplex-ConfigDedicated IE configures UE-specific or UE group-specific uplink, downlink, and SBFD resource configurations. The NE 102 transmits the Duplex-ConfigDedicated IE to the UE 104 via dedicated RRC signaling to establish UE-specific resource pattern configurations that supplement the cell-specific resource patterns configured in the Duplex-ConfigCommon IE. For example, the NE 102 may configure a UE 104 with UE-specific resource patterns to provide additional uplink resources when the UE 104 handles uplink-heavy applications. The NE 102 may also configure a group of UEs with the same UE-specific resource pattern configuration, enabling efficient resource allocation for UEs with similar traffic patterns or locations within the cell.

By configuring different periodicities for different resource patterns, the NE 102 establishes resource occasions for different communication types that occur at different rates, providing greater flexibility than conventional TDD configurations. The timing fields define time domain boundaries of the resource occasion, enabling fine-grained control over resource allocation at both the slot level and the symbol level.

The UE 104 does not expect the Duplex-ConfigDedicated IE to indicate as uplink or as downlink a symbol that the Duplex-ConfigCommon IE indicates as a downlink symbol or as an uplink symbol, respectively. The UE 104 does not expect the Duplex-ConfigDedicated IE to indicate as SBFD a symbol that the Duplex-ConfigCommon IE indicates as a downlink symbol or as an uplink symbol. The UE 104 considers symbols in a slot indicated as downlink by the Duplex-ConfigCommon IE or the Duplex-ConfigDedicated IE to be available for reception and considers symbols in a slot indicated as uplink to be available for transmission. The UE 104 considers a downlink subband in an SBFD symbol to be available for reception and considers an uplink subband in an SBFD symbol to be available for transmission.

When a resource pattern is released, the communication type of the resources previously associated with that resource pattern may change to a different communication type based on a dynamic indication or a semi-static resource configuration for a physical channel or reference signal. The following Tables 7 and 8 provide field descriptions for the Duplex-ConfigDedicated IE and the resourcePattern sequence.

TABLE 7
Duplex-ConfigDedicated field descriptions

resourcePatternToAddModList, resourcePatternToReleaseList
List of resource patterns to add or to modify. List of resource patterns
to release.

TABLE 8
resourcePattern field descriptions

resourcePatternIdentity
Identity of this resource pattern
resourceType
Communication type of this resource pattern

FIG. 8 illustrates a cell activation/deactivation MAC-CE 800 in accordance with aspects of the present disclosure. The cell activation/deactivation MAC-CE structure may implement or be implemented by aspects of the wireless communications system 100 and/or the wireless communications system 200. For example, an NE (e.g., an NE 102) may transmit the cell activation/deactivation MAC-CE to a UE (e.g., a UE 104) to activate or deactivate individual communication types for one or more serving carriers, as described with reference to FIG. 1 and FIG. 2.

The NE 102 transmits the cell activation/deactivation MAC-CE 800 to the UE 104 to control the activation and deactivation of individual communication types for serving carriers. The cell activation/deactivation MAC-CE 800 enables the NE 102 to separately activate or deactivate uplink and downlink resources for each configured cell (e.g., serving carrier), supporting uplink-downlink decoupling across multiple serving carriers. The cell activation/deactivation MAC-CE 800 provides a mechanism for dynamic control of carrier resources that complements the semi-static resource pattern configurations established by the Duplex-ConfigCommon and Duplex-ConfigDedicated information elements.

The cell activation/deactivation MAC-CE 800 comprises two octets identified by a MAC subheader with a predefined LCID. The first octet contains eight bit fields arranged as C0 through C7, and the second octet contains eight bit fields arranged as C8 through C15. This two-octet structure supports activation and deactivation control for up to eight cells, with CellIndex values ranging from 0 to 7. Each bit field indicates an activation status (e.g., activated, deactivated) of a corresponding serving carrier or resource pattern(s). A bit field set to a value 1 indicates that the corresponding serving carrier or resource pattern set is activated, and a bit field set to a value of 0 indicates that the corresponding serving carrier or resource pattern set is deactivated. For each cell, the corresponding respective even-numbered bit fields (C0, C2, C4, C6, C8, C10, C12, C14) correspond to downlink activation or deactivation, and the odd-numbered bit fields (C1, C3, C5, C7, C9, C11, C13, C15) correspond to uplink activation or deactivation.

For example, for a cell configured with CellIndex i, the field C₂ᵢ indicates the activation or deactivation status of a downlink serving carrier (e.g., a serving carrier associated with a downlink communication type) in paired spectrum or a set of downlink resource patterns in unpaired spectrum. The field C₂ᵢ₊₁ indicates the activation or deactivation status of an uplink serving carrier (e.g., a serving carrier associated with an uplink communication type) in paired spectrum or a set of uplink resource patterns in unpaired spectrum. If there is a cell configured with CellIndex i, the MAC entity of the UE processes the C₂ᵢ and C₂ᵢ₊₁ fields; otherwise, the MAC entity ignores these fields.

The cell activation/deactivation MAC-CE 800 enables myriad activation and deactivation combinations for each configured cell. In paired spectrum, the cell activation/deactivation MAC-CE 800 enables separate activation and deactivation of an uplink serving carrier and a downlink serving carrier. In unpaired spectrum, the cell activation/deactivation MAC-CE 800 enables separate activation and deactivation of a set of uplink resource patterns and a set of downlink resource patterns. This capability supports uplink-downlink decoupling, where the NE flexibly matches uplink and downlink communications across different carriers based on factors such as UE location, signal strength, or traffic demands.

When the UE receives the cell activation/deactivation MAC-CE 800, the UE serving processes each bit field to determine the activation or deactivation status of the corresponding carrier or resource pattern set. For cells configured with resource pattern configurations as described with reference to FIGS. 4 and 7, the activation or deactivation indicated by the cell activation/deactivation MAC-CE 800 applies to all resource patterns associated with the indicated communication type for the cell. For example, if the C₂ᵢ₊₁ field is set to 1 for a cell with CellIndex i, all uplink resource patterns configured for that cell are activated. If the C₂ᵢ₊₁ field is set to 0, all uplink resource patterns configured for that cell are deactivated.

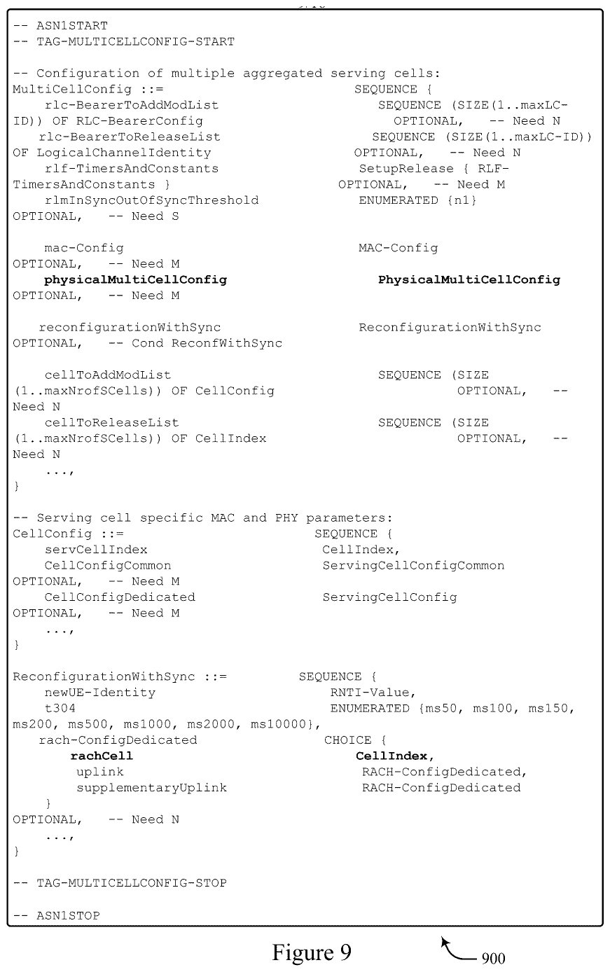

FIG. 9 illustrates an IE 900 used to configure a set of serving cells associated with one MAC entity and a set of logical channels with associated RLC entities, in accordance with aspects of the present disclosure. In some examples, the IE 900 implements or is implemented by aspects of the wireless communications system 100 and/or the wireless communications system 200. For example, an NE (e.g., an NE 102) may transmit, to a UE (e.g., a UE 104), a multi-cell configuration that includes the IE 900 to configure multiple aggregated serving cells and associated parameters for the UE. The IE 900 may be defined as a MultiCellConfig IE.

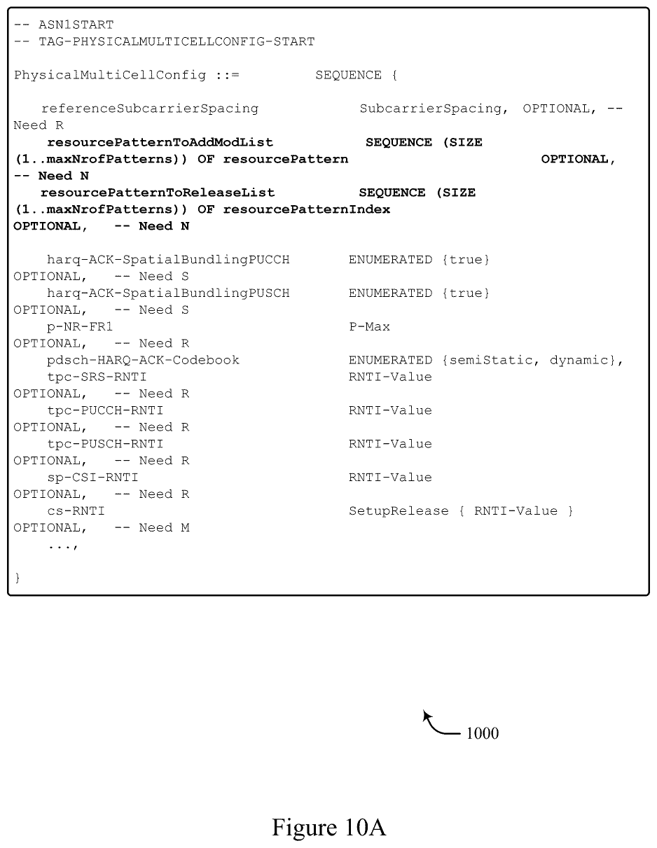

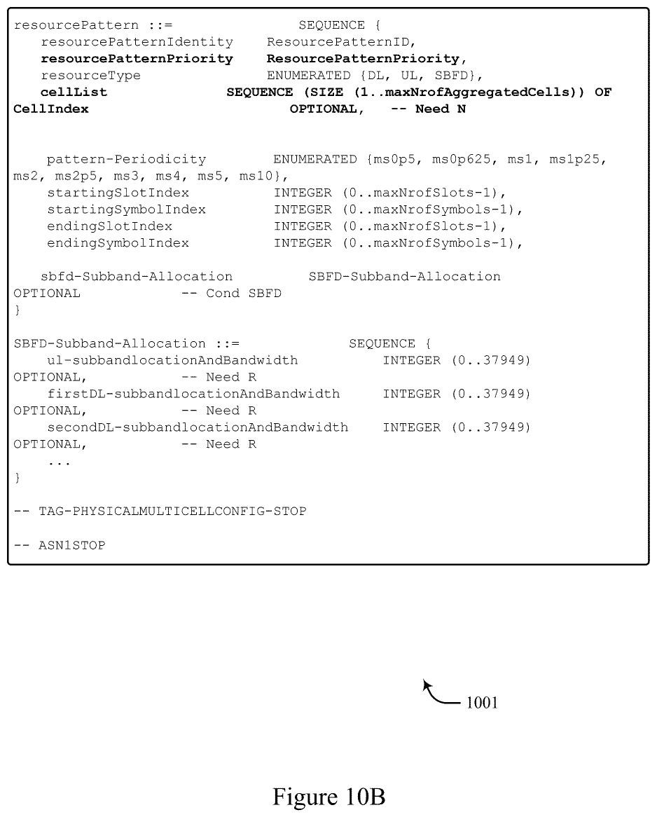

The MultiCellConfig IE is used to configure a set of serving cells associated with one MAC entity and a set of logical channels with associated RLC entities. The NE transmits the MultiCellConfig IE to the UE via RRC signaling to configure multiple aggregated serving cells and associated parameters. The MultiCellConfig IE includes a PhysicalMultiCellConfig field of type PhysicalMultiCellConfig that provides physical layer parameters specific to the set of associated aggregated cells, including resource pattern configurations that apply across subsets of serving carriers, as described with reference to FIGS. 10A and 10B.

The MultiCellConfig IE includes a cellToAddModList field containing a sequence of CellConfig elements for serving cells to be added or modified, and a cellToReleaseList field containing a sequence of CellIndex elements for serving cells to be released. Each CellConfig element includes a servCellIndex field of type CellIndex, a CellConfigCommon field of type ServingCellConfigCommon for common cell configuration, and a CellConfigDedicated field of type ServingCellConfig for dedicated cell configuration. The MultiCellConfig IE further includes a reconfigurationWithSync field of type ReconfigurationWithSync that is conditionally included for reconfiguration with synchronization, such as during handover procedures. The following Tables 9 and 10 provide field descriptions for the MultiCellConfig IE.

TABLE 9
CellGroupConfig field descriptions

rlc-BearerToAddModList
Configuration of the MAC Logical Channel, the corresponding RLC entities and association with radio bearers.
rlc-BearerToReleaseList
List of the RLC entities and the corresponding MAC Logical Channels to be released.
rlmInSyncOutOfSyncThreshold
BLER threshold pair index for IS/OOS indication generation. n1 corresponds to the value 1. When the field is absent,
the UE applies the value 0. Whenever this is reconfigured, UE resets N310 and N311, and stops T310, if running.
rlf-TimersAndConstants
Timers and constants for detecting and triggering radio link failure.
cellToAddModList
List of serving cells to be added or modified.
cellToReleaseList
List of serving cells to be released.
mac-Config
MAC configuration specific to this set of multiple cells.
physicalMultiCellConfig
Physical layer parameters specific to this set of multiple cells.

TABLE 10
ReconfigurationWithSync field descriptions

rach-ConfigDedicated
Random access configuration to be used for the reconfiguration with sync (e.g. handover). The UE performs the
random access according to these parameters in an initial active BWP of a cell indicated by rachCell.

FIGS. 10A and 10B illustrate IE contents 1000 and 1001, respectively, for an IE used to configure layer 1 (L1) parameters for a set of associated (e.g., aggregated) cells, in accordance with aspects of the present disclosure. For example, an NE (e.g., an NE 102) may transmit, to a UE (e.g., a UE 104), a configuration that includes the IE with IE contents 1000 and 1001. The IE may be defined as a PhysicalMultiCellConfig IE and the configured L1 parameters may be specific to the set of associated cells.

The NE transmits the PhysicalMultiCellConfig information element to the UE via RRC signaling to configure physical layer parameters for multiple aggregated serving cells. The PhysicalMultiCellConfig information element establishes L1 parameters that apply across the set of associated aggregated cells, including resource pattern configurations, HARQ-ACK codebook settings, TPC parameters, and various RNTIs. The PhysicalMultiCellConfig information element is included within the MultiCellConfig information element and enables the NE to configure resource patterns that are applicable to subsets of serving carriers, with each resource pattern specifying a communication type, a periodicity, timing information, and a list of cells to which the resource pattern applies.

The serving cells in the cellList may be intra-band, inter-band, in a same frequency range, or in different frequency ranges relative to each other. For resource patterns associated with uplink or downlink communication types, the indicated cells can include any combination of intra-band cells, inter-band cells, and cells in the same or different frequency ranges. For resource patterns associated with full duplex or SBFD communication types, the indicated cells may be limited to intra-band non-contiguous cells, inter-band cells, or cells in different frequency ranges.

For SBFD configurations that apply to multiple serving carriers with different bandwidths, the RIV is defined based on a quantity of RBs corresponding to a minimum bandwidth among the subset of serving carriers indicated in the cellList field, ensuring that the subband allocation fits within all associated carriers. For intra-serving carrier SBFD configurations, each cell in the cellList may have separate frequency information for the resource occasion, providing separate subband configurations per carrier. Alternatively, the same RIV may be applicable to all indicated cells. For inter-serving carrier full duplex operation, the frequency information indicates a first set of serving carriers configured for uplink and a second set of serving carriers configured for downlink. The following Table 11 provides field descriptions for the PhysicalMultiCellConfig IE.

TABLE 11
resourcePattern field descriptions

cellList
A list of cells associated with this resource pattern
resourcePatternPriority
A priority of this resource pattern. When a UE has limited capability for simultaneous transmission and reception in
multi-carrier operation, the UE prioritize transmission or reception scheduled in a higher priority resource pattern.

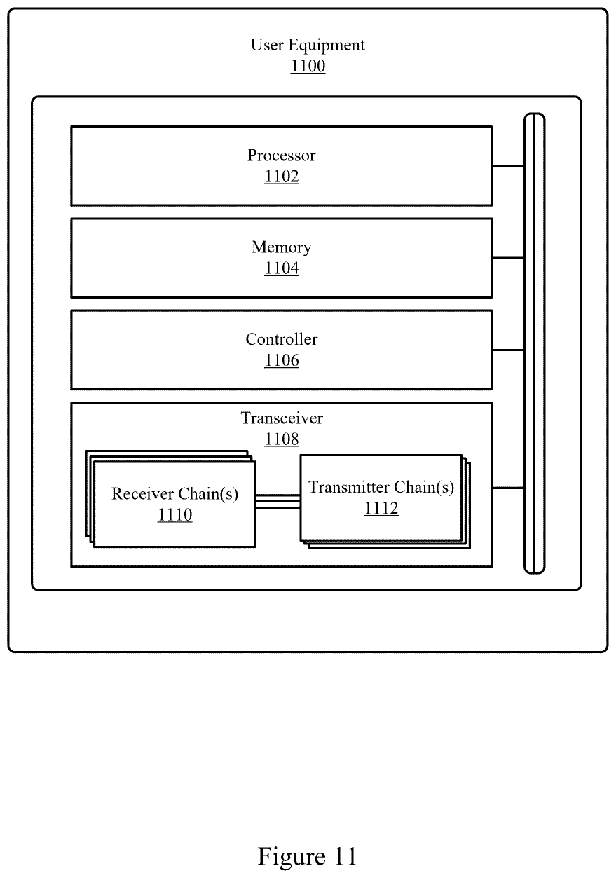

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a central processing unit (CPU), an ASIC, a field-programmable gate-array (FPGA), or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving a set of resource configurations, each resource configuration indicating a pattern of resources, where each pattern of resources is associated with a single respective type of communication, and where each resource configuration further indicates a periodicity of the pattern of resources, and performing the wireless communication in accordance with the set of resource configurations. In this manner, the UE 1100 supports flexible duplexing by enabling independent configuration of resource patterns for different communication types with separate periodicities, improving spectrum utilization efficiency compared to conventional TDD configurations where uplink and downlink resources are constrained to the same periodicity.

Additionally, or alternatively, the UE 1100 may be configured to support any one or combination of the set of resource configurations includes a resource configuration indicating a pattern of resources associated with a flexible type of communication, and a communication direction for the flexible type of communication is determined based on at least one of a dynamic indication, a semi-static resource configuration of a physical channel, or a semi-static resource configuration of a physical signal. This aspect enables dynamic adaptation of resource usage based on traffic demands, improving throughput by allowing resources to be allocated for uplink or downlink as needed.

Additionally, or alternatively, the UE 1100 may be configured to support any one or combination of the set of resource configurations includes a resource configuration indicating a pattern of resources associated with a reserved communication type, and resources indicated by the pattern of resources associated with the reserved communication type are unavailable for the UE 1100. This aspect enables protection of resources for other purposes such as IoT device deployment, improving system reliability by preventing interference with reserved resources. Additionally, or alternatively, the UE 1100 may be configured to support any one or combination of each resource configuration includes a communication type field indicating one of an uplink type of communication, a downlink type of communication, or a SBFD type of communication, and each resource configuration further indicates timing information for at least one resource occasion within the periodicity of the pattern of resources. This aspect enables explicit identification of communication types for each resource pattern, improving configuration clarity and reducing processing overhead for determining resource usage.

Additionally, or alternatively, the UE 1100 may be configured to support any one or combination of the set of resource configurations includes a resource configuration indicating a pattern of resources associated with a SBFD type of communication, and the resource configuration further indicates frequency information for the at least one resource occasion. This aspect enables simultaneous uplink and downlink transmission within a single carrier on different sub-bands, improving spectral efficiency and reducing latency for bidirectional communications. Additionally, or alternatively, the UE 1100 may be configured to support any one or combination of receiving an indication that resources excluded from the set of resource configurations are unavailable for the UE 1100. This aspect provides explicit notification of resource availability, improving reliability by preventing transmission or reception attempts on unavailable resources.

Additionally, or alternatively, the UE 1100 may be configured to support any one or combination of determining a type of communication for resources excluded from the set of resource configurations based on at least one of a dynamic indication, a semi-static resource configuration of a physical channel, or a semi-static resource configuration of a physical signal. This aspect enables flexible use of unconfigured resources based on dynamic scheduling decisions, improving throughput by allowing additional resources to be utilized when available. Additionally, or alternatively, the UE 1100 may be configured to support any one or combination of a pattern of resources associated with an uplink type of communication is nonoverlapping with a first set of resources indicated to the UE 1100 for reception of one or more SSBs, and a second set of resources corresponding to a CORESET for reception of system information. This aspect protects essential downlink signals and channels for cell discovery, improving reliability by ensuring the UE 1100 can maintain synchronization and receive system information.

Additionally, or alternatively, the UE 1100 may be configured to support any one or combination of a pattern of resources associated with a downlink type of communication is nonoverlapping with one or more PRACH occasions. This aspect protects random access opportunities, improving reliability by ensuring the UE 1100 can perform random access procedures without interference from downlink transmissions. Additionally, or alternatively, the UE 1100 may be configured to support any one or combination of the set of resource configurations includes at least one of a cell-specific resource configuration or a UE-specific resource configuration. This aspect enables hierarchical resource configuration with baseline patterns for all devices and tailored patterns for individual devices, improving efficiency by allowing resource allocations to be customized based on traffic demands or device location.

Additionally, or alternatively, the UE 1100 may be configured to support any one or combination of the set of resource configurations includes both the cell-specific resource configuration and the UE-specific resource configuration, and a type of communication for a resource indicated by both the cell-specific resource configuration and the UE-specific resource configuration is determined by the cell-specific resource configuration. This aspect ensures consistent resource usage across devices within a cell by preventing UE-specific configurations from contradicting cell-specific configurations, improving system reliability and reducing interference.

Additionally, or alternatively, the UE 1100 may be configured to support any one or combination of receiving DCI scheduling a PDSCH over a set of slots, and skipping reception of the PDSCH in a slot of the set of slots based on a resource allocated for the PDSCH in the slot overlapping with at least one of a resource occasion of an uplink pattern of resources or an uplink sub-band of a SBFD pattern of resources. This aspect enables proper handling of scheduling conflicts between multi-slot PDSCH reception and uplink resource patterns, improving reliability by preventing reception attempts on resources configured for uplink transmission.

Additionally, or alternatively, the UE 1100 may be configured to support any one or combination of receiving DCI scheduling a PUSCH over a set of slots, and skipping transmission of the PUSCH in a slot of the set of slots based on a resource allocated for the PUSCH in the slot overlapping with at least one of a resource occasion of a downlink pattern of resources or a downlink sub-band of a SBFD pattern of resources. This aspect enables proper handling of scheduling conflicts between multi-slot PUSCH transmission and downlink resource patterns, improving reliability by preventing transmission attempts on resources configured for downlink reception.

Additionally, or alternatively, the UE 1100 may support at least one memory (e.g., the memory 1104) and at least one processor (e.g., the processor 1102) coupled with the at least one memory and configured to cause the UE 1100 to receive a set of resource configurations, each resource configuration indicating a pattern of resources, where each pattern of resources is associated with a single respective type of communication, and where each resource configuration further indicates a periodicity of the pattern of resources, and perform the wireless communication in accordance with the set of resource configurations. In this manner, the UE 1100 supports flexible duplexing by enabling independent configuration of resource patterns for different communication types with separate periodicities, improving spectrum utilization efficiency compared to conventional TDD configurations where uplink and downlink resources are constrained to the same periodicity.

Additionally, or alternatively, the UE 1100 may be configured to support any one or combination of the set of resource configurations includes a resource configuration indicating a pattern of resources associated with a flexible type of communication, and a communication direction for the flexible type of communication is determined based on at least one of a dynamic indication, a semi-static resource configuration of a physical channel, or a semi-static resource configuration of a physical signal. This aspect enables dynamic adaptation of resource usage based on traffic demands, improving throughput by allowing resources to be allocated for uplink or downlink as needed. Additionally, or alternatively, the UE 1100 may be configured to support any one or combination of the set of resource configurations includes a resource configuration indicating a pattern of resources associated with a reserved communication type, and resources indicated by the pattern of resources associated with the reserved communication type are unavailable for the UE 1100. This aspect enables protection of resources for other purposes such as IoT device deployment, improving system reliability by preventing interference with reserved resources.

Additionally, or alternatively, the UE 1100 may be configured to support any one or combination of each resource configuration includes a communication type field indicating one of an uplink type of communication, a downlink type of communication, or a SBFD type of communication, and each resource configuration further indicates timing information for at least one resource occasion within the periodicity of the pattern of resources. This aspect enables explicit identification of communication types for each resource pattern, improving configuration clarity and reducing processing overhead for determining resource usage. Additionally, or alternatively, the UE 1100 may be configured to support any one or combination of the set of resource configurations includes a resource configuration indicating a pattern of resources associated with a SBFD type of communication, and the resource configuration further indicates frequency information for the at least one resource occasion. This aspect enables simultaneous uplink and downlink transmission within a single carrier on different sub-bands, improving spectral efficiency and reducing latency for bidirectional communications.

Additionally, or alternatively, the UE 1100 may be configured to support any one or combination of the one or more processors are further operable to cause the UE 1100 to receive an indication that resources excluded from the set of resource configurations are unavailable for the UE 1100. This aspect provides explicit notification of resource availability, improving reliability by preventing transmission or reception attempts on unavailable resources. Additionally, or alternatively, the UE 1100 may be configured to support any one or combination of the one or more processors are further operable to cause the UE 1100 to determine a type of communication for resources excluded from the set of resource configurations based on at least one of a dynamic indication, a semi-static resource configuration of a physical channel, or a semi-static resource configuration of a physical signal. This aspect enables flexible use of unconfigured resources based on dynamic scheduling decisions, improving throughput by allowing additional resources to be utilized when available.

Additionally, or alternatively, the UE 1100 may be configured to support any one or combination of a pattern of resources associated with an uplink type of communication is nonoverlapping with a first set of resources indicated to the UE 1100 for reception of one or more SSBs, and a second set of resources corresponding to a CORESET for reception of system information. This aspect protects essential downlink signals and channels for cell discovery, improving reliability by ensuring the UE 1100 can maintain synchronization and receive system information.

Additionally, or alternatively, the UE 1100 may be configured to support any one or combination of a pattern of resources associated with a downlink type of communication is nonoverlapping with one or more PRACH occasions. This aspect protects random access opportunities, improving reliability by ensuring the UE 1100 can perform random access procedures without interference from downlink transmissions. Additionally, or alternatively, the UE 1100 may be configured to support any one or combination of the set of resource configurations includes at least one of a cell-specific resource configuration or a UE-specific resource configuration. This aspect enables hierarchical resource configuration with baseline patterns for all devices and tailored patterns for individual devices, improving efficiency by allowing resource allocations to be customized based on traffic demands or device location.

Additionally, or alternatively, the UE 1100 may be configured to support any one or combination of the set of resource configurations includes both the cell-specific resource configuration and the UE-specific resource configuration, and a type of communication for a resource indicated by both the cell-specific resource configuration and the UE-specific resource configuration is determined by the cell-specific resource configuration. This aspect ensures consistent resource usage across devices within a cell by preventing UE-specific configurations from contradicting cell-specific configurations, improving system reliability and reducing interference.

Additionally, or alternatively, the UE 1100 may be configured to support any one or combination of the one or more processors are further operable to cause the UE 1100 to receive DCI scheduling a PDSCH over a set of slots, and skip reception of the PDSCH in a slot of the set of slots based on a resource allocated for the PDSCH in the slot overlapping with at least one of a resource occasion of an uplink pattern of resources or an uplink sub-band of a SBFD pattern of resources. This aspect enables proper handling of scheduling conflicts between multi-slot PDSCH reception and uplink resource patterns, improving reliability by preventing reception attempts on resources configured for uplink transmission.

Additionally, or alternatively, the UE 1100 may be configured to support any one or combination of the one or more processors are further operable to cause the UE 1100 to receive DCI scheduling a PUSCH over a set of slots, and skip transmission of the PUSCH in a slot of the set of slots based on a resource allocated for the PUSCH in the slot overlapping with at least one of a resource occasion of a downlink pattern of resources or a downlink sub-band of a SBFD pattern of resources. This aspect enables proper handling of scheduling conflicts between multi-slot PUSCH transmission and downlink resource patterns, improving reliability by preventing transmission attempts on resources configured for downlink reception.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

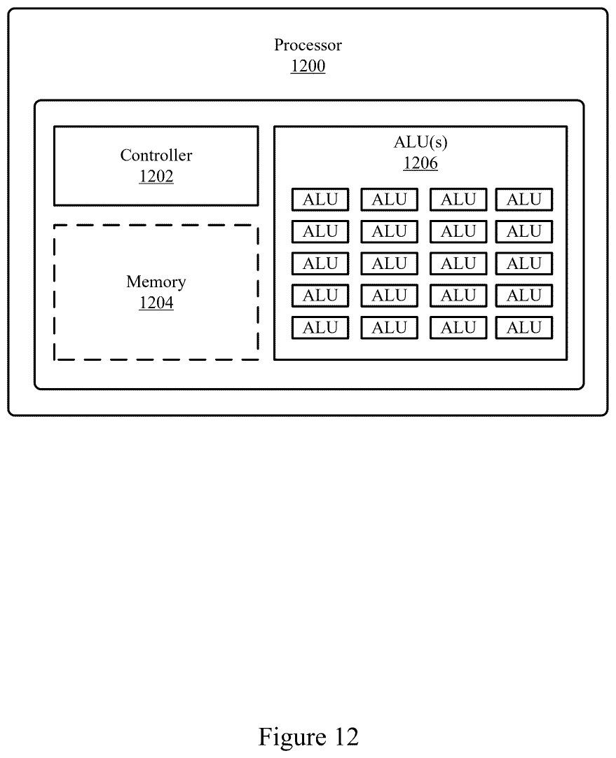

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to receive a set of resource pattern configurations, where each resource pattern configuration is associated with a respective communication type and indicates a resource pattern periodicity and timing information for at least one resource occasion, and perform communications in accordance with the set of resource pattern configurations.

Additionally, or alternatively, the processor 1200 may be configured to or operable to support any one or combination of the set of resource configurations includes a resource configuration indicating a pattern of resources associated with a flexible type of communication, and a communication direction for the flexible type of communication is determined based on at least one of a dynamic indication, a semi-static resource configuration of a physical channel, or a semi-static resource configuration of a physical signal. This aspect enables dynamic adaptation of resource usage based on traffic demands, improving throughput by allowing resources to be allocated for uplink or downlink as needed.

Additionally, or alternatively, the processor 1200 may be configured to or operable to support any one or combination of the set of resource configurations includes a resource configuration indicating a pattern of resources associated with a reserved communication type, and resources indicated by the pattern of resources associated with the reserved communication type are unavailable for the UE. This aspect enables protection of resources for other purposes such as IoT device deployment, improving system reliability by preventing interference with reserved resources. Additionally, or alternatively, the processor 1200 may be configured to or operable to support any one or combination of each resource configuration includes a communication type field indicating one of an uplink type of communication, a downlink type of communication, or a SBFD type of communication, and each resource configuration further indicates timing information for at least one resource occasion within the periodicity of the pattern of resources. This aspect enables explicit identification of communication types for each resource pattern, improving configuration clarity and reducing processing overhead for determining resource usage.

Additionally, or alternatively, the processor 1200 may be configured to or operable to support any one or combination of the set of resource configurations includes a resource configuration indicating a pattern of resources associated with a SBFD type of communication, and the resource configuration further indicates frequency information for the at least one resource occasion. This aspect enables simultaneous uplink and downlink transmission within a single carrier on different sub-bands, improving spectral efficiency and reducing latency for bidirectional communications. Additionally, or alternatively, the processor 1200 may be configured to or operable to support any one or combination of receiving an indication that resources excluded from the set of resource configurations are unavailable for the processor 1200. This aspect provides explicit notification of resource availability, improving reliability by preventing transmission or reception attempts on unavailable resources.

Additionally, or alternatively, the processor 1200 may be configured to or operable to support any one or combination of determining a type of communication for resources excluded from the set of resource configurations based on at least one of a dynamic indication, a semi-static resource configuration of a physical channel, or a semi-static resource configuration of a physical signal. This aspect enables flexible use of unconfigured resources based on dynamic scheduling decisions, improving throughput by allowing additional resources to be utilized when available. Additionally, or alternatively, the processor 1200 may be configured to or operable to support any one or combination of a pattern of resources associated with an uplink type of communication is nonoverlapping with a first set of resources indicated to the processor 1200 for reception of one or more SSBs, and a second set of resources corresponding to a CORESET for reception of system information. This aspect protects essential downlink signals and channels for cell discovery, improving reliability by ensuring the processor 1200 can maintain synchronization and receive system information.

Additionally, or alternatively, the processor 1200 may be configured to or operable to support any one or combination of a pattern of resources associated with a downlink type of communication is nonoverlapping with one or more PRACH occasions. This aspect protects random access opportunities, improving reliability by ensuring the processor 1200 can perform random access procedures without interference from downlink transmissions. Additionally, or alternatively, the processor 1200 may be configured to or operable to support any one or combination of the set of resource configurations includes at least one of a cell-specific resource configuration or a UE-specific resource configuration. This aspect enables hierarchical resource configuration with baseline patterns for all devices and tailored patterns for individual devices, improving efficiency by allowing resource allocations to be customized based on traffic demands or device location.

Additionally, or alternatively, the processor 1200 may be configured to or operable to support any one or combination of the set of resource configurations includes both the cell-specific resource configuration and the UE-specific resource configuration, and a type of communication for a resource indicated by both the cell-specific resource configuration and the UE-specific resource configuration is determined by the cell-specific resource configuration. This aspect ensures consistent resource usage across devices within a cell by preventing UE-specific configurations from contradicting cell-specific configurations, improving system reliability and reducing interference. Additionally, or alternatively, the processor 1200 may be configured to or operable to support any one or combination of receiving DCI scheduling a PDSCH over a set of slots, and skipping reception of the PDSCH in a slot of the set of slots based on a resource allocated for the PDSCH in the slot overlapping with at least one of a resource occasion of an uplink pattern of resources or an uplink sub-band of a SBFD pattern of resources. This aspect enables proper handling of scheduling conflicts between multi-slot PDSCH reception and uplink resource patterns, improving reliability by preventing reception attempts on resources configured for uplink transmission.

Additionally, or alternatively, the processor 1200 may be configured to or operable to support any one or combination of receiving DCI scheduling a PUSCH over a set of slots, and skipping transmission of the PUSCH in a slot of the set of slots based on a resource allocated for the PUSCH in the slot overlapping with at least one of a resource occasion of a downlink pattern of resources or a downlink sub-band of a SBFD pattern of resources. This aspect enables proper handling of scheduling conflicts between multi-slot PUSCH transmission and downlink resource patterns, improving reliability by preventing transmission attempts on resources configured for downlink reception. Additionally, or alternatively, the processor 1200 may be configured to or operable to support at least one controller (e.g., the controller 1202) coupled with at least one memory (e.g., the memory 1204) and configured to cause the processor to transmit, to a UE, a set of resource configurations, each resource configuration indicating a pattern of resources, where each pattern of resources is associated with a single respective type of communication, and where each resource configuration further indicates a periodicity of the pattern of resources, and perform the wireless communication with the UE in accordance with the set of resource configurations. In this manner, the processor 1200 supports flexible duplexing by enabling independent configuration of resource patterns for different communication types with separate periodicities, improving spectrum utilization efficiency compared to conventional TDD configurations where uplink and downlink resources are constrained to the same periodicity.

Additionally, or alternatively, the processor 1200 may be configured to or operable to support any one or combination of each resource configuration includes a communication type field indicating one of an uplink type of communication, a downlink type of communication, or a SBFD type of communication, and each resource configuration further indicates timing information for at least one resource occasion within the periodicity of the pattern of resources. This aspect enables explicit identification of communication types for each resource pattern, improving configuration clarity and reducing processing overhead for determining resource usage. Additionally, or alternatively, the processor 1200 may be configured to or operable to support any one or combination of the set of resource configurations includes at least one of a cell-specific resource configuration or a UE-specific resource configuration. This aspect enables hierarchical resource configuration with baseline patterns for all devices and tailored patterns for individual devices, improving efficiency by allowing resource allocations to be customized based on traffic demands or device location.

Additionally, or alternatively, the processor 1200 may be configured to or operable to support any one or combination of transmitting the cell-specific resource configuration to a set of UEs, and transmitting the UE-specific resource configuration to at least one UE of the set of UEs, where a type of communication for a resource indicated by both the cell-specific resource configuration and the UE-specific resource configuration is determined by the cell-specific resource configuration. This aspect ensures consistent resource usage across devices within a cell by preventing UE-specific configurations from contradicting cell-specific configurations, improving system reliability and reducing interference. Additionally, or alternatively, the processor 1200 may be configured to or operable to support any one or combination of transmitting an indication that resources excluded from the set of resource configurations are unavailable for the UE. This aspect provides explicit notification of resource availability, improving reliability by preventing transmission or reception attempts on unavailable resources.

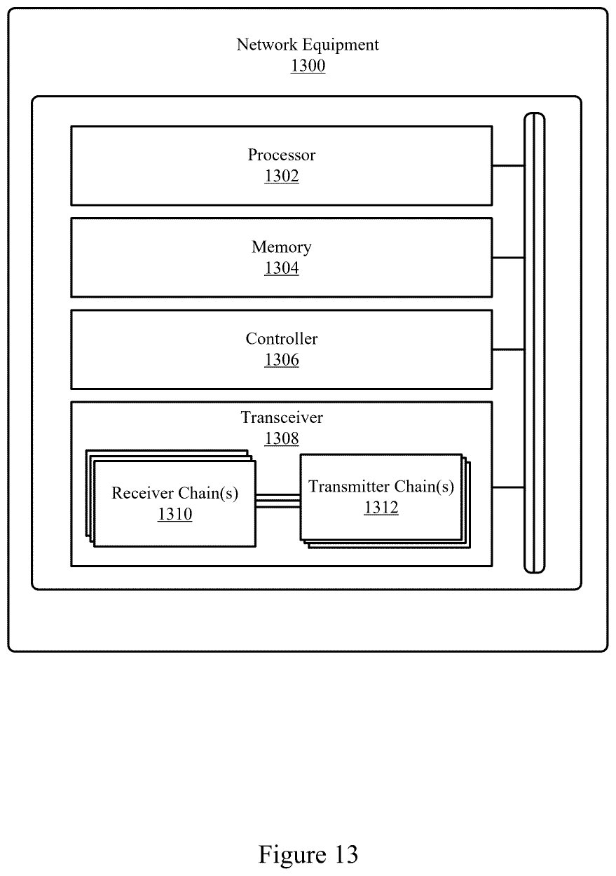

FIG. 13 illustrates an example of an NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to or operable to support a means for transmitting, to a UE, a set of resource configurations, each resource configuration indicating a pattern of resources, where each pattern of resources is associated with a single respective type of communication, and where each resource configuration further indicates a periodicity of the pattern of resources, and performing the wireless communication with the UE in accordance with the set of resource configurations. In this manner, the NE 1300 supports flexible duplexing by enabling independent configuration of resource patterns for different communication types with separate periodicities, improving spectrum utilization efficiency compared to conventional TDD configurations where uplink and downlink resources are constrained to the same periodicity.

Additionally, or alternatively, the NE 1300 may be configured to support any one or combination of each resource configuration includes a communication type field indicating one of an uplink type of communication, a downlink type of communication, or an SBFD type of communication, and each resource configuration further indicates timing information for at least one resource occasion within the periodicity of the pattern of resources. This aspect enables explicit identification of communication types for each resource pattern, improving configuration clarity and reducing processing overhead for determining resource usage. Additionally, or alternatively, the NE 1300 may be configured to support any one or combination of the set of resource configurations includes at least one of a cell-specific resource configuration or a UE-specific resource configuration. This aspect enables hierarchical resource configuration with baseline patterns for all devices and tailored patterns for individual devices, improving efficiency by allowing resource allocations to be customized based on traffic demands or device location.

Additionally, or alternatively, the NE 1300 may be configured to support any one or combination of transmitting the cell-specific resource configuration to a set of UEs, and transmitting the UE-specific resource configuration to at least one UE of the set of UEs, where a type of communication for a resource indicated by both the cell-specific resource configuration and the UE-specific resource configuration is determined by the cell-specific resource configuration. This aspect ensures consistent resource usage across devices within a cell by preventing UE-specific configurations from contradicting cell-specific configurations, improving system reliability and reducing interference. Additionally, or alternatively, the NE 1300 may be configured to support any one or combination of transmitting an indication that resources excluded from the set of resource configurations are unavailable for the UE. This aspect provides explicit notification of resource availability, improving reliability by preventing transmission or reception attempts on unavailable resources.

Additionally, or alternatively, the NE 1300 may support at least one memory (e.g., the memory 1304) and at least one processor (e.g., the processor 1302) coupled with the at least one memory and configured to cause the NE 1300 to transmit, to a UE, a set of resource configurations, each resource configuration indicating a pattern of resources, where each pattern of resources is associated with a single respective type of communication, and where each resource configuration further indicates a periodicity of the pattern of resources, and perform the wireless communication with the UE in accordance with the set of resource configurations. In this manner, the NE 1300 supports flexible duplexing by enabling independent configuration of resource patterns for different communication types with separate periodicities, improving spectrum utilization efficiency compared to conventional TDD configurations where uplink and downlink resources are constrained to the same periodicity.

Additionally, or alternatively, the NE 1300 may be configured to support any one or combination of each resource configuration includes a communication type field indicating one of an uplink type of communication, a downlink type of communication, or an SBFD type of communication, and each resource configuration further indicates timing information for at least one resource occasion within the periodicity of the pattern of resources. This aspect enables explicit identification of communication types for each resource pattern, improving configuration clarity and reducing processing overhead for determining resource usage. Additionally, or alternatively, the NE 1300 may be configured to support any one or combination of the set of resource configurations includes at least one of a cell-specific resource configuration or a UE-specific resource configuration. This aspect enables hierarchical resource configuration with baseline patterns for all devices and tailored patterns for individual devices, improving efficiency by allowing resource allocations to be customized based on traffic demands or device location.

Additionally, or alternatively, the NE 1300 may be configured to support any one or combination of the one or more processors are further operable to cause the NE 1300 to transmit the cell-specific resource configuration to a set of UEs, and transmit the UE-specific resource configuration to at least one UE of the set of UEs, where a type of communication for a resource indicated by both the cell-specific resource configuration and the UE-specific resource configuration is determined by the cell-specific resource configuration. This aspect ensures consistent resource usage across devices within a cell by preventing UE-specific configurations from contradicting cell-specific configurations, improving system reliability and reducing interference. Additionally, or alternatively, the NE 1300 may be configured to support any one or combination of the one or more processors are further operable to cause the NE 1300 to transmit an indication that resources excluded from the set of resource configurations are unavailable for the UE. This aspect provides explicit notification of resource availability, improving reliability by preventing transmission or reception attempts on unavailable resources.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., an LNA) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

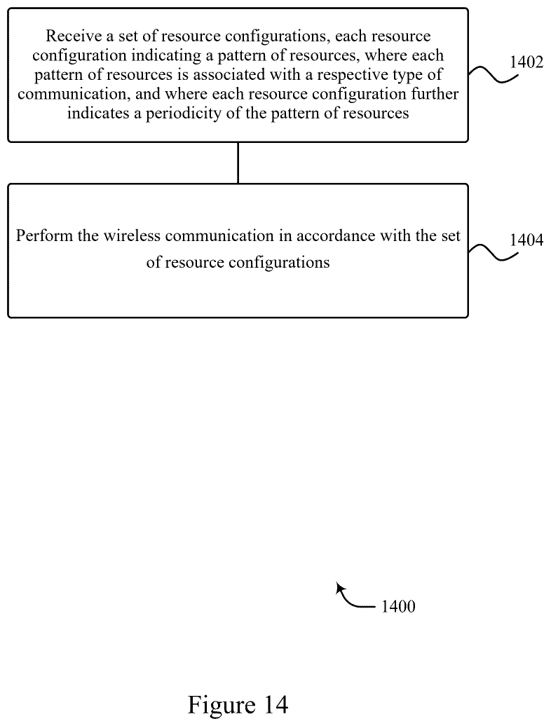

FIG. 14 illustrates a flowchart of a method 1400 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1402, the method may include receiving a set of resource configurations, each resource configuration indicating a pattern of resources, where each pattern of resources is associated with a single respective type of communication, and where each resource configuration further indicates a periodicity of the pattern of resources. The operations of 1402 may be performed in accordance with examples as described herein. In some implementations, aspects of the operations of 1402 may be performed by a UE as described with reference to FIG. 11.

At 1404, the method may include performing the wireless communication in accordance with the set of resource configurations. The operations of 1404 may be performed in accordance with examples as described herein. In some implementations, aspects of the operations of 1404 may be performed by a UE as described with reference to FIG. 11.

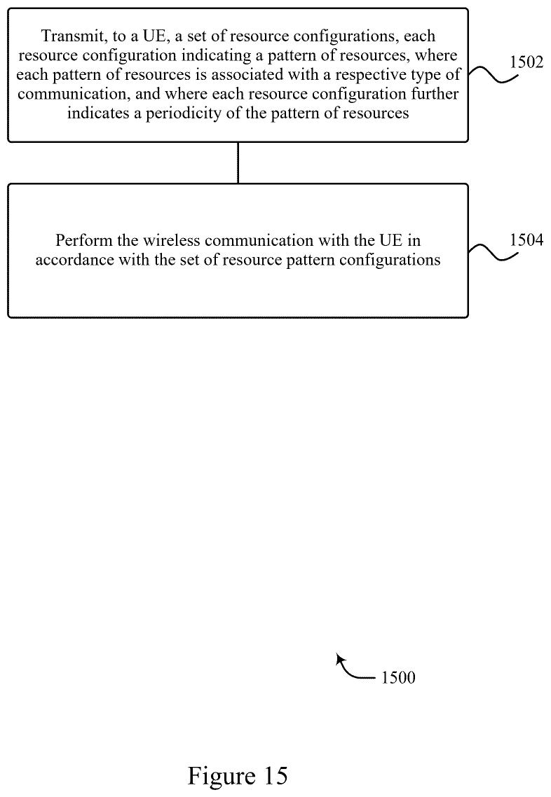

FIG. 15 illustrates a flowchart of a method 1500 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include transmitting, to a UE, a set of resource configurations, each resource configuration indicating a pattern of resources, where each pattern of resources is associated with a single respective type of communication, and where each resource configuration further indicates a periodicity of the pattern of resources. The operations of 1502 may be performed in accordance with examples as described herein. In some implementations, aspects of the operations of 1502 may be performed by an NE as described with reference to FIG. 13.

At 1504, the method may include performing the wireless communication with the UE in accordance with the set of resource configurations. The operations of 1504 may be performed in accordance with examples as described herein. In some implementations, aspects of the operations of 1504 may be performed by an NE as described with reference to FIG. 13.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively operable to cause the UE to:
receive a set of resource configurations, each resource configuration indicating a pattern of resources, wherein each pattern of resources is associated with a single respective type of communication, and wherein each resource configuration further indicates a periodicity of the pattern of resources; and
perform the wireless communication in accordance with the set of resource configurations.

2. The UE of claim 1, wherein:
the set of resource configurations includes a resource configuration indicating a pattern of resources associated with a flexible type of communication; and
a communication direction for the flexible type of communication is determined based at least in part on at least one of a dynamic indication, a semi-static resource configuration of a physical channel, or a semi-static resource configuration of a physical signal.

3. The UE of claim 1, wherein:
the set of resource configurations includes a resource configuration indicating a pattern of resources associated with a reserved communication type; and
resources indicated by the pattern of resources associated with the reserved communication type are unavailable for the UE.

4. The UE of claim 1, wherein:
each resource configuration includes a communication type field indicating one of an uplink type of communication, a downlink type of communication, or a sub-band full duplex (SBFD) type of communication; and
each resource configuration further indicates timing information for at least one resource occasion within the periodicity of the pattern of resources.

5. The UE of claim 4, wherein:
the set of resource configurations includes a resource configuration indicating a pattern of resources associated with a sub-band full duplex (SBFD) type of communication; and
the resource configuration further indicates frequency information for the at least one resource occasion.

6. The UE of claim 1, wherein the one or more processors are further operable to cause the UE to receive an indication that resources excluded from the set of resource configurations are unavailable for the UE.

7. The UE of claim 1, wherein the one or more processors are further operable to cause the UE to determine a type communication for resources excluded from the set of resource configurations based at least in part on at least one of a dynamic indication, a semi-static resource configuration of a physical channel, or a semi-static resource configuration of a physical signal.

8. The UE of claim 1, wherein a pattern of resources associated with an uplink type of communication is nonoverlapping with:
a first set of resources indicated to the UE for reception of one or more synchronization signal blocks; and
a second set of resources corresponding to a control resource set (CORESET) for reception of system information.

9. The UE of claim 1, wherein a pattern of resources associated with a downlink type of communication is nonoverlapping with one or more physical random access channel (PRACH) occasions.

10. The UE of claim 1, wherein the set of resource configurations includes at least one of a cell-specific resource configuration or a UE-specific resource configuration.

11. The UE of claim 10, wherein:
the set of resource configurations includes both the cell-specific resource configuration and the UE-specific resource configuration; and
a type of communication for a resource indicated by both the cell-specific resource configuration and the UE-specific resource configuration is determined by the cell-specific resource configuration.

12. The UE of claim 1, wherein the one or more processors are further operable to cause the UE to:
receive downlink control information (DCI) scheduling a physical downlink shared channel (PDSCH) over a plurality of slots; and
skip reception of the PDSCH in a slot of the plurality of slots based at least in part on a resource allocated for the PDSCH in the slot overlapping with at least one of a resource occasion of an uplink pattern of resources or an uplink sub-band of a sub-band full duplex (SBFD) pattern of resources.

13. The UE of claim 1, wherein the one or more processors are further operable to cause the UE to:
receive downlink control information (DCI) scheduling a physical uplink shared channel (PUSCH) over a plurality of slots; and
skip transmission of the PUSCH in a slot of the plurality of slots based at least in part on a resource allocated for the PUSCH in the slot overlapping with at least one of a resource occasion of a downlink pattern of resources or a downlink sub-band of a sub-band full duplex (SBFD) pattern of resources.

14. A network entity (NE) for wireless communication, comprising:
one or more memories; and
one or more processors coupled with the one or more memories and individually or collectively operable to cause the NE to:
transmit, to a user equipment (UE), a set of resource configurations, each resource configuration indicating a pattern of resources, wherein each pattern of resources is associated with a single respective type of communication, and wherein each resource configuration further indicates a periodicity of the pattern of resources; and
perform the wireless communication with the UE in accordance with the set of resource configurations.

15. The NE of claim 14, wherein each resource configuration includes a communication type field indicating one of an uplink type of communication, a downlink type of communication, or a sub-band full duplex (SBFD) type of communication; and
each resource configuration further indicates timing information for at least one resource occasion within the periodicity of the pattern of resources.

16. The NE of claim 14, wherein the set of resource configurations includes at least one of a cell-specific resource configuration or a UE-specific resource configuration.

17. The NE of claim 16, wherein the one or more processors are further operable to cause the NE to:
transmit the cell-specific resource configuration to a plurality of UEs; and
transmit the UE-specific resource configuration to at least one UE of the plurality of UEs, wherein a type of communication for a resource indicated by both the cell-specific resource configuration and the UE-specific resource configuration is determined by the cell-specific resource configuration.

18. The NE of claim 17, wherein the one or more processors are further operable to cause the NE to transmit an indication that resources excluded from the set of resource configurations are unavailable for the UE.

19. A method performed by a user equipment (UE) for wireless communication, the method comprising:
receiving a set of resource configurations, each resource configuration indicating a pattern of resources, wherein each pattern of resources is associated with a respective type of communication, and wherein each resource configuration further indicates a periodicity of the pattern of resources; and
performing the wireless communication in accordance with the set of resource configurations.

20. A method performed by a network entity (NE) for wireless communication, the method comprising:
transmitting, to a user equipment (UE), a set of resource configurations, each resource pattern indicating a pattern of resources, wherein each pattern of resources is associated with a respective type of communication, and wherein each resource configuration further indicates a periodicity of the pattern of resources; and
performing the wireless communication with the UE in accordance with the set of resource configurations.
